(19) United States
(12) Patent Application Publication
(10) Pub. No.: US 2020/0364021 A1
(43) Pub. Date: Nov. 19, 2020

(54) ELECTRONIC DEVICE CONTROLLING SCREEN BASED ON FOLDING EVENT AND METHOD FOR CONTROLLING THE SAME

(71) Applicant: Samsung Electronics Co., Ltd., Suwon-si (KR)

(72) Inventors: Jeongmin PARK, Suwon-si (KR); Jongjin KIM, Suwon-si (KR); Jonghwan SHIN, Suwon-si (KR); Sukjae LEE, Suwon-si (KR); Junhee CHO, Suwon-si (KR); Changryong HEO, Suwon-si (KR)

(21) Appl. No.: 15/929,685

(22) Filed: May 15, 2020

(30) Foreign Application Priority Data
May 17, 2019 (KR) 10-2019-0057757

(51) Int. Cl. G06F 3/14; H04N 5/247; H04N 5/225; H04N 5/232; H04N 5/45; H04N 5/445; G06F 1/16

(52) U.S. Cl. CPC G06F 3/1446; H04N 5/247; H04N 5/2257; H04N 5/23245; H04N 5/45; G06F 3/0482; H04N 5/23293; G06F 1/1616; G06F 1/1652; G06F 1/1681; G06F 1/1686; H04N 5/44591

(57) ABSTRACT

An electronic device controlling a screen based on a folding event and a method for controlling the same. According to an embodiment, an electronic device comprises a plurality of cameras, a foldable housing including a first hinge structure and a second hinge structure, a flexible display at least partially exposed through the foldable housing, and at least one processor provided in the foldable housing. The at least one processor is configured to display on the flexible display a first screen including an object obtained by a first camera among the plurality of cameras, detect a folding event for at least one of the first hinge structure and the second hinge structure while displaying the obtained first screen on the flexible display, and display a second screen different from the first screen on the flexible display according to the detected folding event.

### CROSS-REFERENCE TO RELATED APPLICATION

This application is based on and claims priority under 35 U.S.C. 119 to Korean Patent Application No. 10-2019-0057757, filed on May 17, 2019, in the Korean Intellectual Property Office, the disclosure of which is herein incorporated by reference in its entirety.

### BACKGROUND

### 1. Field

Various embodiments of the disclosure relate to an electronic device controlling the screen based on a folding event and method for controlling the same.

### 2. Description of Related Art

More and more services and additional functions are being provided through electronic devices, e.g., smartphones, or other portable electronic devices. To meet users' various needs and raise use efficiency of electronic devices, communication service carriers or device manufacturers are jumping into competitions to develop electronic devices with differentiated and diversified functionalities. Accordingly, various functions that are provided through electronic devices are evolving more and more.

A foldable electronic device, e.g., a single foldable electronic device with one hinge structure, may have a specific state (e.g., active state/inactive state) defined depending on when it is folded or unfolded. However, a multi-foldable electronic device with a plurality of hinge structures, unlike the single foldable electronic device, may have various states defined depending on when it is folded or unfolded.

The above information is presented as background information only to assist with an understanding of the disclosure. No determination has been made, and no assertion is made, as to whether any of the above might be applicable as prior art with regard to the disclosure.

### SUMMARY

According to an embodiment, there is provided a multi-foldable electronic device with a plurality of hinge structures, capable of providing various functions depending on folding angles of the hinge structures.

According to an embodiment, there is provided a method for controlling a multi-foldable electronic device with a plurality of hinge structures, capable of providing various functions depending on folding states (e.g., angles) of the hinge structures.

In accordance with various embodiments, an electronic device comprises a plurality of cameras, a foldable housing including a first hinge structure and a second hinge structure, a flexible display at least partially exposed through the foldable housing, and at least one processor provided in the foldable housing, the at least one processor configured to display a first screen including an object obtained by a first camera among the plurality of cameras on the flexible display, detect a folding event for at least one of the first hinge structure and the second hinge structure while displaying the obtained first screen on the flexible display, and display a second screen different from the first screen on the flexible display according to the detected folding event.

In accordance with various embodiments, a method for controlling an electronic device comprises displaying a first screen including an object obtained by at least one of a plurality of cameras of the electronic device on a flexible display of the electronic device, detecting a folding event for a first hinge structure of the electronic device while displaying the obtained first screen on the flexible display, the first hinge structure connected with a first housing having the plurality of cameras, and switching a second screen different from the first screen and display the second screen according to the detected folding event.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates a block diagram illustrating an electronic device in a network environment according to an embodiment;

FIG. 2 is a view illustrating an unfolded state of an electronic device according to an embodiment;

FIG. 3 is a view illustrating a folded state of an electronic device according to an embodiment;

FIG. 4 is an exploded perspective view illustrating an electronic device according to an embodiment;

FIG. 5A is a view illustrating an unfolded state of an electronic device according to an embodiment;

FIG. 5B is a cross-sectional view schematically illustrating a side surface of an electronic device according to an embodiment;

FIG. 6A is a view illustrating an angle sensor according to an embodiment;

FIGS. 6B and 6C are views illustrating a folding angle according to an embodiment;

FIG. 7 is a view illustrating a folded state of an electronic device according to an embodiment;

FIG. 8A is a view illustrating an unfolded state of an electronic device according to an embodiment;

FIG. 8B is a cross-sectional view schematically illustrating a side surface of an electronic device according to an embodiment;

FIG. 8C is a view illustrating an operation of folding an electronic device according to an embodiment;

FIGS. 9A and 9B are views illustrating a folding angle according to an embodiment;

FIGS. 10A, 10B, 10C, and 10D are views illustrating a function or operation of switching an operation mode of a camera application according to first hinge structure folds;

FIG. 10E is a view illustrating an example of changing a camera as an example of switching an operation mode of a camera application as a first hinge structure folds;

FIGS. 11A, 11B, 11C, and 11D are views illustrating a function or operation of shrinking a display area where a screen is displayed when a folding event on a second hinge structure occurs, with a first hinge structure folded;

FIGS. 12A and 12B are views illustrating a function or operation of terminating an application being executed when a folding event occurs on a second hinge structure, with a first hinge structure folded;

FIGS. 13A, 13B, 13C, 13D, 13E, 13F, and 13G are views illustrating a function or operation of shrinking a display area where a screen is displayed when a folding event on a second hinge structure occurs, with a first hinge structure unfolded;

FIGS. 14A, 14B, 14C, 14D, 14E, 14F, 14G, and 14H are views illustrating a function or operation of continuously (e.g., seamlessly) switching screens when a folding event on a second hinge structure occurs, with a first hinge structure unfolded;

FIGS. 15A and 15B are views illustrating a function or operation of continuously (e.g., seamlessly) switching screens when a folding event occurs on a second hinge structure, with a first hinge structure folded;

FIGS. 16A, 16B, and 16C are views illustrating a function or operation of switching the screen being displayed on an electronic device when a folding event occurs on a second hinge structure;

FIGS. 17A, 17B, and 17C are views illustrating a function or operation of providing a designated graphic interface for applying a visual effect to an object being displayed on an electronic device when a folding event occurs on a second hinge structure;

FIGS. 18A and 18B are views illustrating a function or operation for providing a graphic interface for executing a designated function when a folding event occurs on a second hinge structure; and

FIG. 19 is a view illustrating a method of operating an electronic device according to an embodiment.

Throughout the drawings, like reference numerals will be understood to refer to like parts, components, and structures.

### DETAILED DESCRIPTION

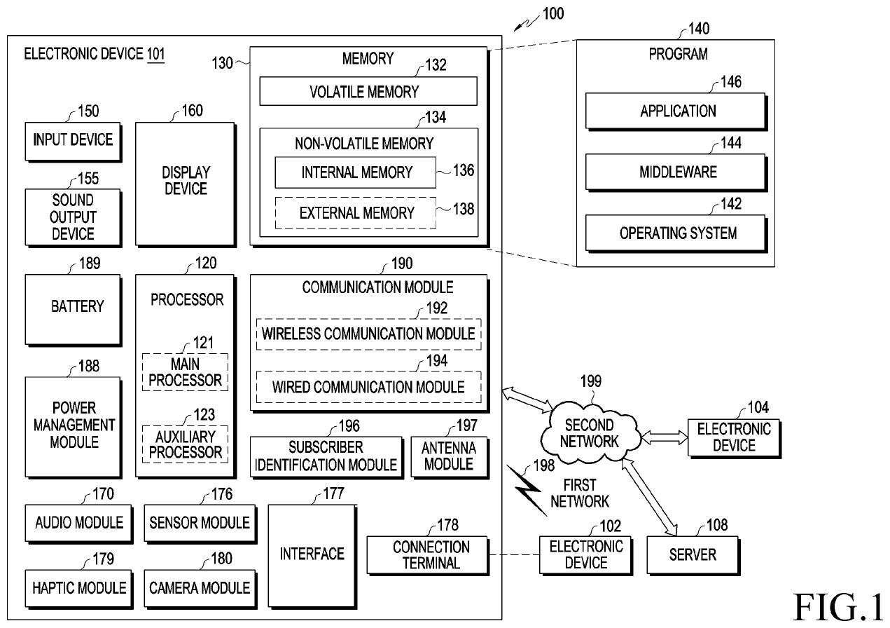

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is a block diagram illustrating an electronic device 101 in a network environment 100 according to an embodiment.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, e.g., software (e.g., a program 140) to control at least one other component (e.g., a hardware or software component) of the electronic device 101 connected with the processor 120 and may process or compute various data. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a pen input device (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain a sound through the input device 150 or output a sound through the sound output device 155 or an external electronic device (e.g., an electronic device 102 (e.g., a speaker or a headphone) directly or wirelessly connected with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or wireless communication channel between the electronic device 101 and an external electronic device (e.g., the electronic device 102, the electronic device 104, or the server 108) and performing communication through the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas. In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 and 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

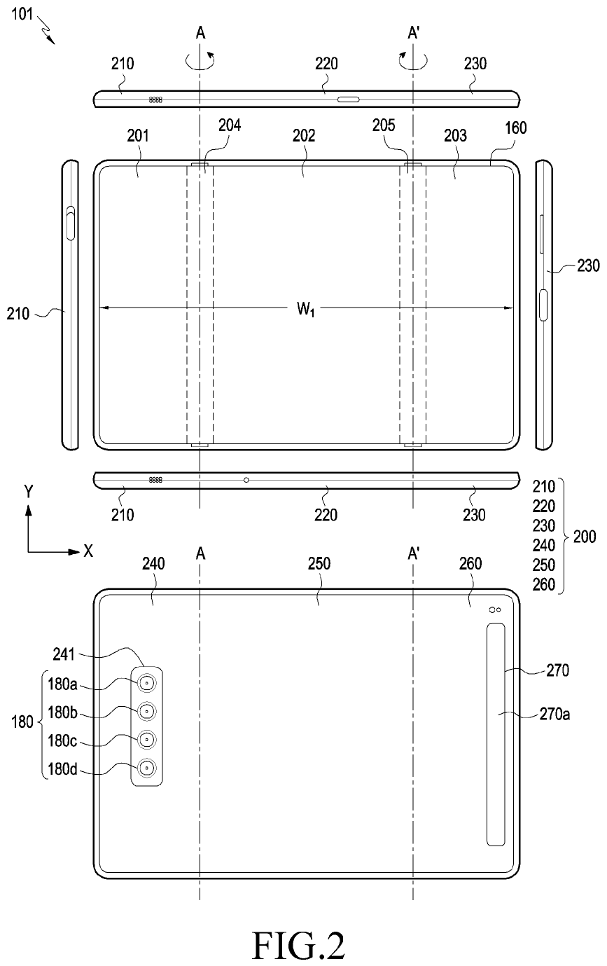

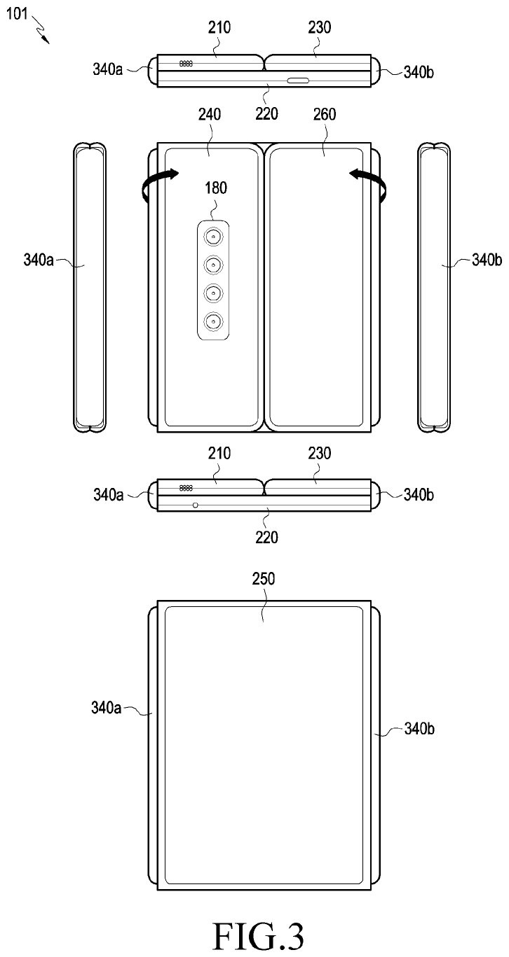

FIG. 2 is a view illustrating an unfolded state of an electronic device 101 according to an embodiment. FIG. 3 is a view illustrating a folded state of an electronic device 101 according to an embodiment.

Referring to FIGS. 2 and 3, an electronic device 101 may include a foldable housing 200, a hinge cover (e.g., a first hinge cover 340a and second hinge cover 340b of FIG. 3) covering a foldable portion of the foldable housing 200, and a display device 160 (e.g., a flexible or foldable display) disposed in a space formed by the foldable housing 200. In this disclosure, for ease of description, the surface where the display device 160 is disposed is defined as a front surface of the electronic device 101, and the surface facing away from the front surface is defined as a back surface of the electronic device 101. The surface surrounding the space between the front and back surfaces is defined as a side surface of the electronic device 101.

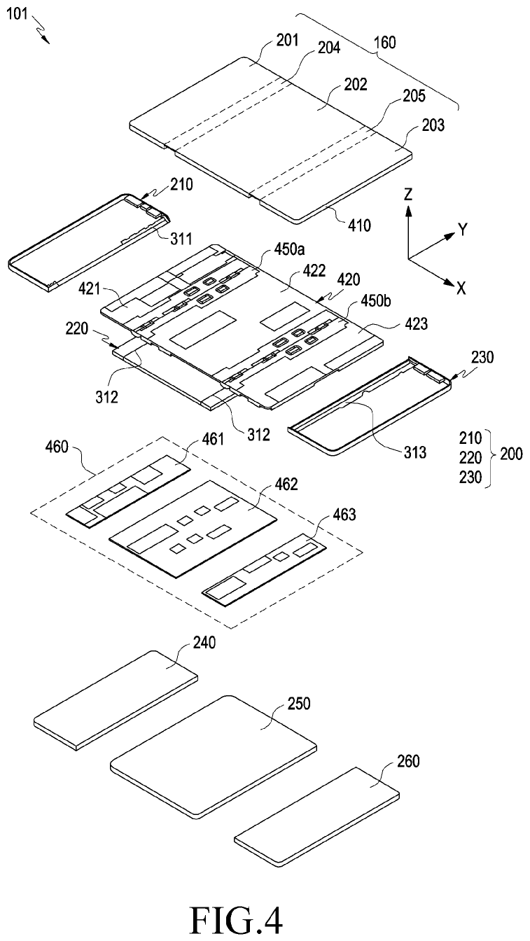

According to an embodiment, the foldable housing 200 may include a first housing structure 210, a second housing structure 220, a third housing structure 230, a first back cover 240, a second back cover 250, a third back cover 260, and a hinge structure (e.g., the first hinge structure 450a and second hinge structure 450b of FIG. 4). According to an embodiment, the foldable housing 200 of the electronic device 101 is not limited to the shape and coupling shown in FIGS. 2 and 3 but may rather be implemented in other shapes or via a combination and/or coupling of other components. For example, according to another embodiment, the first housing structure 210 and the first back cover 240 may be integrally formed with each other, and the second housing structure 220 and the second back cover 250 may be integrally formed with each other. The third housing structure 230 and the third back cover 260 may be integrally formed with each other.

According to an embodiment, the first housing structure 210 may be connected to the hinge structure (e.g., the first hinge structure 450a of FIG. 4) and may include a first surface facing in a first direction and a second surface facing in a second direction opposite to the first direction. According to an embodiment, the second housing structure 220 may be connected to the hinge structure (e.g., the first hinge structure 450a and second hinge structure 450b of FIG. 4) and may include a third surface facing in a third direction and a fourth surface facing in a fourth direction opposite to the third direction. According to an embodiment, the first housing structure 210 may rotate from the second housing structure 220 on the hinge structure (e.g., the first hinge structure 450a of FIG. 4). Thus, the electronic device 101 may turn into a folded state or unfolded state. According to an embodiment, in the folded state of the electronic device 101, the first surface may face the third surface and, in the unfolded state, the third direction may be identical to the first direction. According to an embodiment, the third housing structure 230 may be connected to the hinge structure (e.g., the second hinge structure 450b of FIG. 4) and may include a fifth surface facing in a fifth direction and a sixth surface facing in a sixth direction opposite to the fifth direction. According to an embodiment, the third housing structure 230 may rotate from the second housing structure 220 on the hinge structure (e.g., the second hinge structure 450b of FIG. 4). Thus, the electronic device 101 may turn into a folded state or unfolded state. According to an embodiment, in the folded state of the electronic device 101, the fifth surface may face the third surface and, in the unfolded state, the fifth direction may be identical to the third direction.

According to an embodiment, the first housing structure 210 and the second housing structure 220 may be disposed on both sides of a folding axis A, and the second housing structure 220 and the third housing structure 230 may be disposed on both sides of a folding axis A′. As set forth above, the first housing structure 210, the second housing structure 220, and the third housing structure 230 may have different angles or distances formed therebetween depending on whether the electronic device 101 is in the unfolded, folded, or partially unfolded state. According to an embodiment, as shown in FIG. 2, the first housing structure 210, the second housing structure 220, and the third housing structure 230 together may form a recess for receiving the display device 160. According to an embodiment, the recess may have a first width w1.

According to an embodiment, the first housing structure 210 and the second housing structure 220 may at least partially be formed of a metal or non-metallic material with a rigidity selected to support the display device 160. According to an embodiment, at least a portion formed of metal may provide a ground plane of the electronic device 101 and may be electrically connected with a ground line formed on a printed circuit board (e.g., the board unit 460 of FIG. 4).

According to an embodiment, the first back cover 240 may be disposed on one side of the folding axis on the back surface of the electronic device 101 and have a substantially rectangular periphery which may be surrounded by the first housing structure 210. Similarly, the second back cover 250 may be disposed on the opposite side of the folding axis A on the back surface of the electronic device 101 and its periphery may be surrounded by the second housing structure 220. Similarly, the third back cover 260 may be disposed on the opposite side of the folding axis A′ on the back surface of the electronic device 101 and its periphery may be surrounded by the third housing structure 230. According to an embodiment, the first back cover 240 may be integrally formed with the first housing structure 210, and the second back cover 250 may be integrally formed with the second housing structure 220. The third back cover 260 may be integrally formed with the third housing structure 230.

According to an embodiment, the first back cover 240, the second back cover 250, the third back cover 260, the first housing structure 210, the second housing structure 220, and the third housing structure 230 may form a space where various components (e.g., a printed circuit board or battery) of the electronic device 101 may be arranged. According to an embodiment, one or more components may be arranged or visually exposed on/through the back surface of the electronic device 101. For example, at least a portion of a sub display 270a may be visually exposed through a first back surface area 270 of the third back cover 260. According to an embodiment, one or more components or sensors may be visually exposed through a designated area of the third back cover 260 or second back cover 250. According to an embodiment, the sub display 270a may take up most of the third back cover 260 or may be disposed on another back cover.

According to an embodiment, the camera 180 exposed through the designated back surface area 241 of the first back cover 240 may include one or more lenses, an image sensor, and/or an image signal processor. According to an embodiment, the camera 180 may include at least one of a plurality of cameras (e.g., a first camera 180a, a second camera 180b, a third camera 180c, and a fourth camera 180d). According to an embodiment, the first camera 180a may include a wide angle camera. According to an embodiment, the wide angle camera may include a lens with an angle of view ranging from 60 degrees to 120 degrees. According to an embodiment, the second camera 180b may include a telephoto camera. According to an embodiment, the second camera 180b may include a telephoto lens. According to an embodiment, the second camera 180b may have an angle of view (e.g., 30 degrees or less) smaller in range than the first camera. According to an embodiment, the third camera 180c may include a normal camera with a standard lens. According to an embodiment, the third camera 180c may include a lens with an angle of view (e.g., ranging from 40 degrees to 50 degrees) between that of the first camera 180a and that of the second camera 180b. According to an embodiment, the fourth camera 180d may include a depth camera capable of identifying the depth of the target object.

Referring to FIG. 3, according to an embodiment, the first hinge cover 340a may be disposed between the first housing structure 210 and the second housing structure 220 to hide the internal components (e.g., the first hinge structure 450a of FIG. 4). According to an embodiment, the second hinge cover 340b may be disposed between the second housing structure 220 and the third housing structure 230 to hide the internal components (e.g., the second hinge structure 450b of FIG. 4). According to an embodiment, the hinge cover (e.g., the first hinge cover 340a or second hinge cover 340b) may be hidden by a portion of the first housing structure 210, second housing structure 220, and the third housing structure 230 or be exposed to the outside depending on the state (e.g., the unfolded (or flat) state, intermediate state, or folded state) of the electronic device 101.

According to an embodiment, as shown in FIG. 2, in the unfolded state of the electronic device 101, the hinge cover 340a or 340b may be hidden, and thus not be exposed, by the first housing structure 210, the second housing structure 220, and the third housing structure 230. According to an embodiment, as shown in FIG. 3, in the folded state (e.g., the fully folded state) of the electronic device 101, the first hinge cover 340a may be exposed to the outside between the first housing structure 210 and the second housing structure 220. As shown in FIG. 3, in the folded state (e.g., the fully folded state) of the electronic device 101, the second hinge cover 340b may be exposed to the outside between the second housing structure 220 and the third housing structure 230. According to an embodiment, in an intermediate state in which the first housing structure 210 and the second housing structure 220 are folded with a certain angle, a portion of the first hinge cover 340a may be exposed to the outside between the first housing structure 210 and the second housing structure 220. In an intermediate state in which the second housing structure 220 and the third housing structure 230 are folded with a certain angle, a portion of the second hinge cover 340b may be exposed to the outside between the second housing structure 220 and the third housing structure 230. In this case, the exposed area may be smaller than when the electronic device 101 is in the fully folded state. According to an embodiment, the first hinge cover 340a and the second hinge cover 340b may have a curved surface.

According to an embodiment, the display device 160 may be disposed in a space formed by the foldable housing 200. For example, the display device 160 may be seated in a recess formed by the foldable housing 200 and may occupy most of the front surface of the electronic device 101. For example, the front surface of the electronic device 101 may include the display device 160, a partial area of the first housing structure 210, a partial area of the second housing structure 220, and a partial area of the third housing structure 230, which are adjacent to the display device 160. The back surface of the electronic device 101 may include the first back cover 240, a partial area of the first housing structure 210, which is adjacent to the first back cover 240, the second back cover 250, a partial area of the second housing structure 220, which is adjacent to the second back cover 250, the third back cover 260, and a partial area of the third housing structure 230, which is adjacent to the third back cover 260.

According to an embodiment, the display device 160 may include a display with at least a partial area turning flat or curved. According to an embodiment, the display device 160 may include a first folding area 204, a first area 201 on a side (e.g., the left side of the first folding area 204 of FIG. 2) of the first folding area 204 and a second area 202 on the opposite side (e.g., the right side of the first folding area 204 of FIG. 2 or the left side of the second folding area 205) of the first folding area 204, and a third area 203 on a side (e.g., the right side of the second folding area 205) of the second folding area 205. According to an embodiment, the display device 160 may be disposed to be coupled with, or adjacent, a touch detecting circuit, a pressure sensor capable of measuring the strength (pressure) of touches, and/or a digitizer for detecting a magnetic field-type stylus pen.

Described below are the operation of the first housing structure 210, the second housing structure 220, and the third housing structure 230 and each area of the display device 160 depending on the state (e.g., the folded, unfolded, or intermediate state) of the electronic device 101.

According to an embodiment, in the unfolded state (e.g., as shown in FIG. 2) of the electronic device 101, the first housing structure 210, the second housing structure 220, and the third housing structure 230 may be arranged to be substantially 180-degree angled therebetween while facing in the same direction. According to an embodiment, the surface of the first area 201, surface of the second area 202, and surface of the third area 203 of the display device 160 are angled at 180 degrees therebetween while facing in the same direction (e.g., forward of the front surface of the electronic device). According to an embodiment, the first folding area 204 and the second folding area 205 may be flush with the first area 201, second area 202, and third area 203.

According to an embodiment, when the electronic device 101 is in the folded state (e.g., the state as shown in FIG. 3), the first housing structure 210 and the second housing structure 220 may face each other. According to an embodiment, when the electronic device 101 is in the folded state (e.g., the state as shown in FIG. 3), the second housing structure 220 and the third housing structure 230 may face each other. According to an embodiment, the surface of the first area 201 of the display device 160 and the surface of the second area 202 may be angled at a small angle (e.g., ranging from 0 degrees to 10 degrees) therebetween. According to an embodiment, the surface of the second area 202 of the display device 160 and the surface of the third area 203 may be angled at a small angle (e.g., ranging from 0 degrees to 10 degrees) therebetween. According to an embodiment, the first folding area 204 and the second folding area 205 may have at least a portion which is a curved surface with a predetermined curvature.

According to an embodiment, in the intermediate state of the electronic device 101, the first housing structure 210 and the second housing structure 220 may be arranged at a certain angle therebetween. According to an embodiment, in the intermediate state of the electronic device 101, the second housing structure 220 and the third housing structure 230 may be arranged at a certain angle therebetween. According to an embodiment, the surface of the first area 201 of the display device 160 and the surface of the second area 202 may be positioned therebetween at an angle which is larger than the angle in the folded state and smaller than the angle in the unfolded state. According to an embodiment, the surface of the second area 202 of the display device 160 and the surface of the third area 203 may be positioned therebetween at an angle which is larger than the angle in the folded state and smaller than the angle in the unfolded state. According to an embodiment, the first folding area 204 and the second folding area 205 may have at least a portion which is a curved surface with a predetermined curvature. The curvature may be smaller than that in the folded state.

FIG. 4 is an exploded perspective view illustrating an electronic device according to an embodiment.

Referring to FIG. 4, according to an embodiment, an electronic device 101 may include a foldable housing 200, a display device 160, and a board unit 460. According to an embodiment, the foldable housing 200 may include a first housing structure 210, a second housing structure 220, a third housing structure 230, a first back cover 240, a second back cover 250, a third back cover 260, a bracket assembly 420, a first hinge structure 450a, and a second hinge structure 450b.

According to an embodiment, the display device 160 may include a display panel (e.g., a flexible display panel) and one or more plates or layers (e.g., a supporting plate 410) on which the display panel is seated. According to an embodiment, the supporting plate 410 may be disposed between the display panel and the bracket assembly 420. According to an embodiment, an adhesive structure may be positioned between the supporting plate 410 and the bracket assembly 420, attaching the supporting plate 410 and the bracket assembly 420.

According to an embodiment, the bracket assembly 420 may include a first supporting plate 421, a second supporting plate 422, and a third supporting plate 423. According to an embodiment, the first hinge structure 450a may be disposed between the first supporting plate 421 and the second supporting plate 422 and, when viewed from above the back surface, with the first hinge structure 450a unfolded, a hinge cover 340a covering the first hinge structure 450a may be disposed. According to an embodiment, the second hinge structure 450b may be disposed between the second supporting plate 422 and the third supporting plate 423 and, when viewed from above the back surface, with the second hinge structure 450b unfolded, the hinge cover 340b covering the second hinge structure 450b may be disposed. According to an embodiment, a printed circuit board (e.g., a flexible printed circuit board (FPCB)) may be disposed to cross the first supporting plate 421, the second supporting plate 422, and the third supporting plate 423.

According to an embodiment, the board unit 460 may include a first main circuit board 461 disposed on a side of the first supporting plate 421, a second main circuit board 462 disposed on a side of the second supporting plate 422, and a third main circuit board 463 disposed on a side of the third supporting plate 423. According to an embodiment, the first main circuit board 461, the second main circuit board 462, and the third main circuit board 463 may be disposed in a space formed by the bracket assembly 420, the first housing structure 210, the second housing structure 220, the third housing structure 230, the first back cover 240, the second back cover 250, and the third back cover 260. According to an embodiment, components for implementing various functions of the electronic device 101 may be mounted on the first main circuit board 461, the second main circuit board 462, and the third main circuit board 463.

According to an embodiment, the first housing structure 210 and the third housing structure 230 may be assembled together to be fitted at both sides of the bracket assembly 420, with the display device 160 combined with the bracket assembly 420. For example, the first housing structure 210 and the third housing structure 230 may slide to both sides of the bracket assembly 420 and fit with the bracket assembly 420. According to an embodiment, the second housing structure 220 may be assembled to fit with the bracket assembly 420 from one side to another (e.g., from down to up), with the first housing structure 210 and the third housing structure 230 fitted with the bracket assembly 420. For example, the second housing structure 220 may slide from one side to another (e.g., from down to up), with the first housing structure 210 and the third housing structure 230 fitted with the bracket assembly 420, and may be joined with the bracket assembly 420, the first housing structure 210, and the third housing structure 230.

According to an embodiment, the first housing structure 210 may include a first rotation supporting surface 311, and the third housing structure 230 may include a second rotation supporting surface 313. According to an embodiment, the second housing structure 220 may include third rotation supporting surfaces 312 individually corresponding to the first rotation supporting surface 311 and the second rotation supporting surface 313. According to an embodiment, the first rotation supporting surface 311, second rotation supporting surface 313, and third rotation supporting surfaces 312 may include a curved surface corresponding to the hinge cover (e.g., the first hinge cover 340a or second hinge cover 340b of FIG. 3).

According to an embodiment, in the unfolded state of the electronic device 101 (e.g., as in the electronic device of FIG. 2), the first rotation supporting surface 311 and the second rotation supporting surface 313, respectively, may cover the first hinge cover 340a and the second hinge cover 340b, allowing for no or minimal exposure of the first hinge cover 340a and second hinge cover 340b to the back surface of the electronic device 101. According to an embodiment, in the folded state of the electronic device 101 (e.g., as in the electronic device of FIG. 3), the first rotation supporting surface 311, the second rotation supporting surface 313, and the third rotation supporting surfaces 312 may rotate along the curved surfaces of the first hinge cover 340a and second hinge cover 340b, allowing for maximal exposure of the first hinge cover 340a and second hinge cover 340b to the back surface of the electronic device 101.

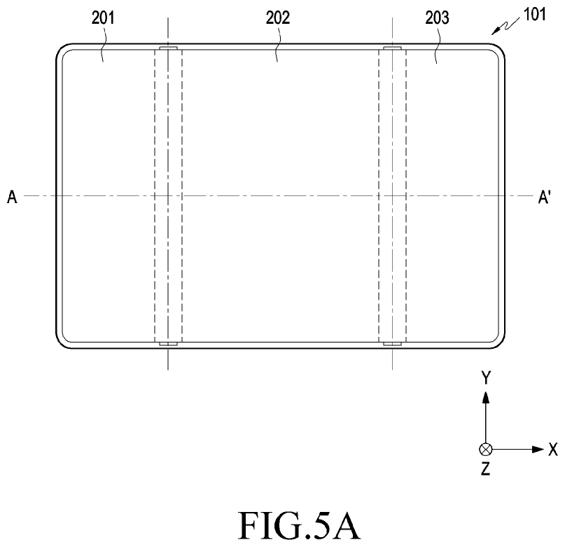

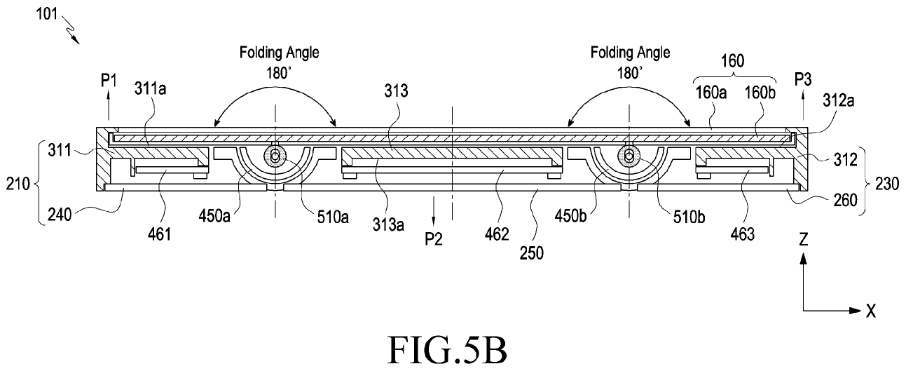

FIG. 5A is a view illustrating an unfolded state of an electronic device 101 according to an embodiment. According to an embodiment, the hinge structures (e.g., the first hinge structure 450a and the second hinge structure 450b) of the electronic device 101 may rotate in different directions.

FIG. 5B is a cross-sectional view schematically illustrating a side surface of an electronic device 101 according to an embodiment. For example, FIG. 5B is a cross-sectional view taken along line A-A′ of the electronic device 101 as shown in FIG. 5A.

According to an embodiment, the first housing structure 210 may include a first surface 311a facing in a first direction P1. According to an embodiment, the second housing structure 220 may include a second surface 313a facing in a second direction P2. According to an embodiment, the third housing structure 330 may include a third surface 312a facing in a third direction. According to an embodiment, the first direction P1, the second direction P2, and the third direction P3 may turn from the same to opposite as the first hinge structure 450a and the second hinge structure 450b rotate. For example, in the folded state of the foldable housing 200, the first surface 311a may face the second surface 313a and, in the unfolded state, the third direction may be the same as the first direction.

According to an embodiment, the display device 160 may be disposed on the first surface 311a through on the third surface 312a. According to an embodiment, the display device 160 may include a front plate 160a and a display panel 160b, and a bracket assembly (e.g., the bracket assembly 420 of FIG. 4) may be disposed under the display device 160 to support the display device 160.

According to an embodiment, the front plate 160a may be formed at least partially of a substantially transparent material. For example, the front plate 160a may be formed of a glass plate or polymer plate with various coat layers.

According to an embodiment, the display panel 160b may be shown through a significant portion of the front plate 160a. According to an embodiment, the edge of the display panel 160b may be formed to have substantially the same shape as the adjacent periphery of the front plate 160a. According to an embodiment, to increase the area where the display panel 160b is shown, the edge-to-edge interval of the display panel 160b may be substantially the same as the edge-to-edge interval of the front plate 160a.

According to an embodiment, the display device 160 may, at least partially, be formed of a material that transmits radio waves or magnetic fields. According to an embodiment, the display panel 160b and/or touch panel may be equipped in the display device 160. For example, the display device 160 may be utilized as an input device packing touchscreen functionality as well as an output device for outputting screen. According to an embodiment, the display panel 160b (e.g., an (active-matrix) organic light emitting diode) may include a display element layer with at least one pixel(s) and a thin film transistor (TFT) layer connected with the display element layer.

According to an embodiment, the bracket assembly (e.g., the bracket assembly 420 of FIG. 4) may be disposed on the back and/or side surface of the display panel 160b to at least partially surround the front plate 160a and display panel 160b, supporting them. According to an embodiment, the bracket assembly (e.g., the bracket assembly 420 of FIG. 4) may include one or more plates, e.g., sus plate, where the display device 160 sits.

According to an embodiment, at least one sensor (first sensor 510a and second sensor 510b) may be disposed in the foldable housing and sense the operation state of the foldable housing. According to an embodiment, at least one sensor (first sensor 510a and second sensor 510b) may include at least one of, e.g., an angle sensor, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. The at least one sensor may sense the operation state and generate an electrical signal or data corresponding to the sensed state.

According to an embodiment, the at least one sensor (e.g., the first sensor 510a) may include an angle sensor (e.g., a rotary sensor), and the angle sensor may be disposed to connect with a hinge structure (e.g., the first hinge structure 450a) to measure the angle between the surfaces facing each other in the folded state. According to an embodiment, the at least one sensor (e.g., the second sensor 510b) may include an angle sensor (e.g., a rotary sensor), and the angle sensor may be disposed to connect with a hinge structure (e.g., the second hinge structure 450b) to measure the angle between the surfaces facing each other in the folded state. According to an embodiment, the at least one sensor (e.g., the first sensor 510a and the second sensor 510b) may include a magnetic sensor (e.g., a hall sensor) and may be disposed in the first housing structure 210, the second housing structure 220, or the third housing structure 230. According to an embodiment, the magnetic sensor may sense the folded state of the foldable housing. According to an embodiment, the at least one sensor may include a stretch sensor capable of determining the degree of folding of the hinge structure (e.g., the first hinge structure 450a or second hinge structure 450b).

According to an embodiment, the electronic device may include a processor 120 and a memory 130. According to an embodiment, the processor 120 may execute, for example, software to control at least one other component (e.g., a hardware or software component) of the electronic device 101 coupled with the processor 120, and may perform various data processing or computation. For example, according to an embodiment, the processor 120 may be disposed in the first housing structure 210, the second housing structure 220, and/or the third housing structure 230 and may be operatively connected with the display device 160 and at least one sensor (first sensor 510a or second sensor 510b). According to an embodiment, the processor 120 may provide an instruction or data received from at least one of the display device 160 or the at least one sensor (first sensor 510a or second sensor 510b) to the volatile memory of the memory 130, process the instruction or data stored in the volatile memory, and store the resultant data in the non-volatile memory. According to an embodiment, the memory 130 may store various data used by at least one component (e.g., the processor 120) of the electronic device 101.

According to an embodiment, the electronic device 101 may include a hinge structure (e.g., the first hinge structure 450a or second hinge structure 450b) and a board unit 460. According to an embodiment, the hinge structure (e.g., the first hinge structure 450a or second hinge structure 450b) may be disposed on a left or right side of the center of the foldable housing, and the first housing structure 210 may rotate from the second housing structure 220 on the first hinge structure 450a. According to an embodiment, the third housing structure 230 may rotate from the second housing structure 220 on the second hinge structure 450b.

According to an embodiment, the first housing structure 210 may be connected with the first hinge structure 450a and may include the first main circuit board 461. According to an embodiment, the second housing structure 220 may be connected with the first hinge structure 450a and the second hinge structure 450b and may include the second main circuit board 462. According to an embodiment, the third housing structure 230 may be connected with the second hinge structure 450b and may include the third main circuit board 463. According to an embodiment, when viewed from outside, the hinge structure (e.g., the first hinge structure 450a or second hinge structure 450b) may include a hinge cover covering the hinge structure (e.g., the first hinge structure 450a or second hinge structure 450b), and the hinge cover may be disposed to face the display device 160. According to an embodiment, a flexible printed circuit board (FPCB) may be disposed to cross the first housing structure 210 and the second housing structure 220, and the second housing structure 220 and the third housing structure 230.

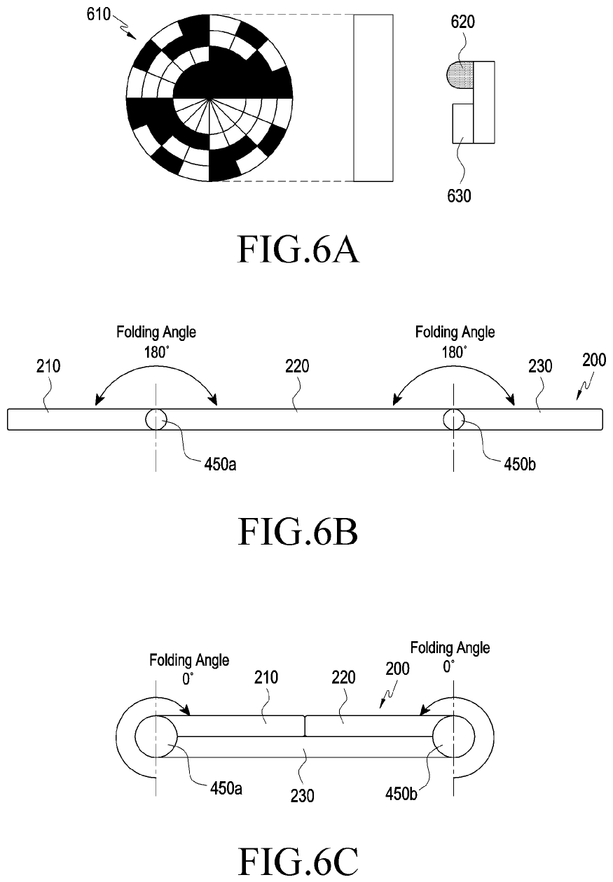

FIG. 6A is a view illustrating an angle sensor according to an embodiment.

According to an embodiment, the angle sensor may include an angle sensor of an angle encoder manner. According to an embodiment, the angle sensor may emit light to a pattern 610 attached to a portion of the hinge structure (e.g., the first hinge structure 450a or second hinge structure 450b) and receive the light reflected by the pattern 610, allowing the image sensor 630 or processor to identify the pattern 610. According to an embodiment, light may be output from a light emitting element 620 (e.g., an LED). According to an embodiment, the pattern 610 may be engraved or colored every predetermined angle and, thus, when irradiated with light, differences in light absorption or reflection may occur. According to an embodiment, the image sensor 630 or processor (e.g., the processor 120 of FIG. 1) may identify the light reflected by the pattern 610, thereby identifying the rotating angle of the hinge structure (e.g., the first hinge structure 450a or second hinge structure 450b). According to an embodiment, the image sensor 630 or processor (e.g., the processor 120 of FIG. 1) may identify the angle every 22.5 degrees, but this is merely an example.

FIGS. 6B and 6C are views illustrating a folding angle according to an embodiment.

Referring to FIG. 6B, according to an embodiment, the foldable housing 200 may include a hinge structure (e.g., the first hinge structure 450a or second hinge structure 450b), a first housing structure 210, a second housing structure 220, and a third housing structure 230. FIG. 6B illustrates an example in which the first housing structure 210, second housing structure 220, and third housing structure 230 are in the fully unfolded state. In the disclosure, for ease of description, the folding angle in the fully unfolded state of the first housing structure 210, second housing structure 220, and third housing structure 230 may be defined as 180 degrees. However, this is merely an example. The folding angle in the fully unfolded state of the first housing structure 210, second housing structure 220, and third housing structure 230 may be defined as 0 degrees.

Referring to FIG. 6C, according to an embodiment, the foldable housing 200 may include a hinge structure (e.g., the first hinge structure 450a or second hinge structure 450b), a first housing structure 210, a second housing structure 220, and a third housing structure 230. FIG. 6C illustrates an example in which the first housing structure 210, second housing structure 220, and third housing structure 230 are in the fully folded state. In the disclosure, for ease of description, the folding angle in the fully folded state of the first housing structure 210, second housing structure 220, and third housing structure 230 may be defined as 0 degrees. However, this is merely an example. The folding angle in the fully unfolded state of the first housing structure 210, second housing structure 220, and third housing structure 230 may be defined as 180 degrees.

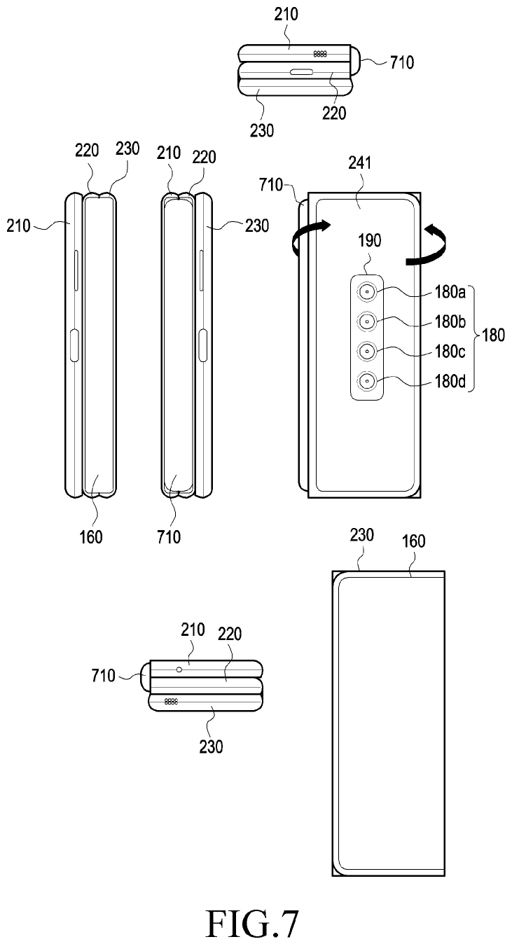

FIG. 7 is a view illustrating a folded state of an electronic device 101 according to an embodiment.

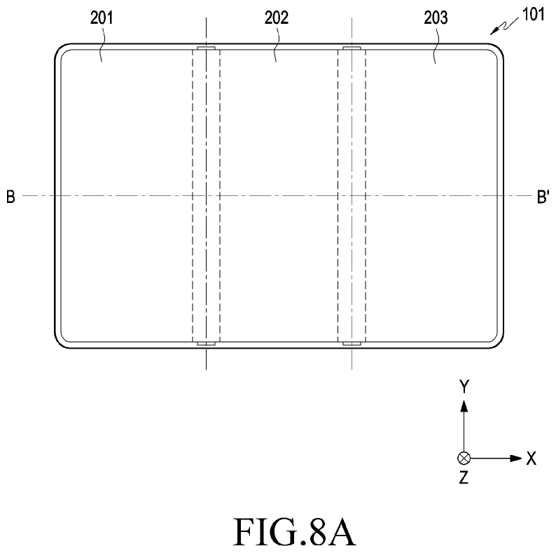

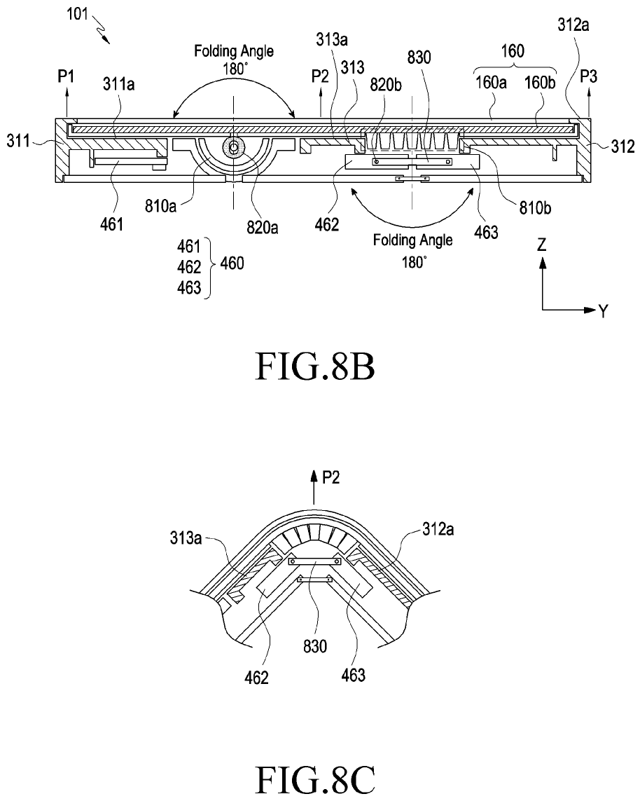

Referring to FIG. 7, according to an embodiment, the electronic device 101 may include a first housing structure 210, a second housing structure 220, and a third housing structure 230. According to an embodiment, the first housing structure 210 may rotate on the third hinge structure (e.g., the third hinge structure 810a of FIG. 8B) in a first direction. According to an embodiment, the third housing structure 230 may rotate on the fourth hinge structure (e.g., the fourth hinge structure 810b of FIG. 8B) in a second direction. According to an embodiment, the first direction may be the same as the second direction.

According to an embodiment, the camera 180 exposed through the designated back surface area 241 of the first back cover 240 may include one or more lenses, an image sensor, and/or an image signal processor. According to an embodiment, the camera 180 may include at least one of a plurality of cameras (e.g., a first camera 180a, a second camera 180b, a third camera 180c, and a fourth camera 180d). According to an embodiment, the first camera 180a may include a wide angle camera. According to an embodiment, the wide angle camera may include a lens with an angle of view ranging from 60 degrees to 120 degrees. According to an embodiment, the second camera 180b may include a telephoto camera. According to an embodiment, the second camera 180b may include a telephoto lens. According to an embodiment, the second camera 180b may have an angle of view (e.g., 30 degrees or less) smaller in range than the first camera. According to an embodiment, the third camera 180c may include a normal camera with a standard lens. According to an embodiment, the third camera 180c may include a lens with an angle of view (e.g., ranging from 40 degrees to 50 degrees) between that of the first camera 180a and that of the second camera 180b. According to an embodiment, the fourth camera 180d may include a depth camera capable of identifying the depth of the target object.

According to an embodiment, the third hinge cover 710 may be disposed between the first housing structure 210 and the second housing structure 220 to hide the internal components (e.g., the third hinge structure 810a of FIG. 8). According to an embodiment, the hinge cover (e.g., the third hinge cover 710) may be hidden, or exposed to the outside, by a portion of the first housing structure 210 and the second housing structure 220 depending on the state (e.g., the flat, intermediate, or folded state) of the electronic device 101. According to an embodiment, the third hinge structure 810a may be folded in an in-folding manner (e.g., the display device 160 is folded inwards), and the fourth hinge structure 810b may be folded in an out-folding manner (e.g., the back cover is folded outwards). Thus, if the first hinge structure and the second hinge structure both are fully folded, at least a portion of the flexible display 160 may be exposed to the outside.

FIG. 8A is a view illustrating an unfolded state of an electronic device according to an embodiment. According to an embodiment, the hinge structures (e.g., the first hinge structure 450a and the second hinge structure 450b) of the electronic device 101 may rotate in the same direction.

FIG. 8B is a cross-sectional view schematically illustrating a side surface of an electronic device 101 according to an embodiment. For example, FIG. 8B is a cross-sectional view taken along line B-B′ of the electronic device 101 as shown in FIG. 8A.

According to an embodiment, the first rotation supporting surface 311 may include a first surface 311a facing in a first direction P1. According to an embodiment, the second rotation supporting surface 313 may include a second surface 313a facing in a second direction P2. According to an embodiment, the third rotation supporting surface 312 may include a third surface 312a facing in a third direction P3. According to an embodiment, the first direction and the second direction may turn from the same to opposite as the third hinge structure 810 rotates. For example, in the folded state of the foldable housing 200, the first surface 311a may face the second surface 313a and, in the unfolded state, the second direction P2 may be the same as the first direction P1. According to an embodiment, the second direction P2 and the third direction P3 may turn from the same to opposite as the fourth hinge structure 810b rotates. For example, in the unfolded state of the foldable housing 200, the third direction P3 may be the same as the second direction P2 and, in the folded state, the third surface 312a may be disposed to face away from the second surface 313a.

According to an embodiment, the display device 160 may be disposed on the first surface 311a through on the third surface 312a. According to an embodiment, the display device 160 may include a front plate 160a and a display panel 160b, and a bracket assembly (e.g., the bracket assembly 420 of FIG. 4) may be disposed under the display device 160 to support the display device 160.

According to an embodiment, the front plate 160a may be formed at least partially of a substantially transparent material. For example, the front plate 160a may be formed of a glass plate or polymer plate with various coat layers.

According to an embodiment, the display panel 160b may be shown through a significant portion of the front plate 160a. According to an embodiment, the edge of the display panel 160b may be formed to have substantially the same shape as the adjacent periphery of the front plate 160a. According to an embodiment, to increase the area where the display panel 160b is shown, the edge-to-edge interval of the display panel 160b may be substantially the same as the edge-to-edge interval of the front plate 160a.

According to an embodiment, the display device 160 may, at least partially, be formed of a material that transmits radio waves or magnetic fields. According to an embodiment, the display panel 160b and/or touch panel may be equipped in the display device 160. For example, the display device 160 may be utilized as an input device packing touchscreen functionality as well as an output device for outputting screen. According to an embodiment, the display panel 160b (e.g., an (active-matrix) organic light emitting diode) may include a display element layer with at least one pixel(s) and a thin film transistor (TFT) layer connected with the display element layer.

According to an embodiment, at least one sensor (third sensor 820a and fourth sensor 820b) may be disposed in the foldable housing 200 and sense the operation state of the foldable housing 200. According to an embodiment, at least one sensor (third sensor 820a and fourth sensor 820b) may include at least one of, e.g., an angle sensor, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. The at least one sensor may sense the operation state and generate an electrical signal or data corresponding to the sensed state.

According to an embodiment, the at least one sensor (e.g., the third sensor 820a) may include an angle sensor (e.g., a rotary sensor), and the angle sensor may be disposed to connect with a hinge structure (e.g., the third hinge structure 810a) to measure the angle between the first surface 311a and the second surface 313a. According to an embodiment, the at least one sensor (e.g., the fourth sensor 820b) may include an angle sensor (e.g., a rotary sensor). According to an embodiment, the at least one sensor (e.g., the fourth sensor 820b) may measure the angle between the second housing structure 220 and the third housing structure 230. According to an embodiment, the at least one sensor (e.g., the third sensor 820a and the fourth sensor 820b) may include a magnetic sensor (e.g., a hall sensor) and may be disposed in the first housing structure 210, the second housing structure 220, or the third housing structure 230. According to an embodiment, the magnetic sensor may sense the folded state of the foldable housing 200. According to an embodiment, the at least one sensor may include a stretch sensor capable of determining the degree of folding of the hinge structure (e.g., the third hinge structure 810a or fourth hinge structure 810b).

According to an embodiment, the electronic device 101 may include a hinge structure (e.g., the third hinge structure 810a or fourth hinge structure 810b) and a board unit 460. According to an embodiment, the hinge structure (e.g., the third hinge structure 810a or fourth hinge structure 810b) may be disposed on a left or right side of the center of the foldable housing 200, and the first housing structure 210 may rotate from the second housing structure 220 on the third hinge structure 810a.

According to an embodiment, the first housing structure (e.g., the first housing structure 210 of FIG. 7) may be connected with the third hinge structure 810a and may include the first main circuit board 461. According to an embodiment, the second housing structure (e.g., the second housing structure 220 of FIG. 7) may be connected with the third hinge structure 810a and fourth hinge structure 810b and may include the second main circuit board 462. According to an embodiment, the third housing structure (e.g., the third housing structure 230 of FIG. 7) may be connected with the fourth hinge structure 810b and may include the third main circuit board 463. According to an embodiment, when viewed from above the back surface in the unfolded state, the hinge structure (e.g., the third hinge structure 810a) may include a hinge cover covering the hinge structure (e.g., the third hinge structure 810a), and the hinge cover may be disposed to face the display device 160. According to an embodiment, a flexible printed circuit board (FPCB) may be disposed to cross the first housing structure 210 and the second housing structure 220, and the second housing structure 220 and the third housing structure 230. According to an embodiment, the second main circuit board 462 and the third main circuit board 463 may be connected via a connecting member 830. According to an embodiment, the connecting member 830 may rotatably fasten the second main circuit board 462 and the third main circuit board 463. According to an embodiment, if a folding event occurs on the fourth hinge structure 810b, the second main circuit board 462 and third main circuit board 463 may push up the fourth hinge structure 810b in a first direction (e.g., the P2 direction) as shown in FIG. 8C. According to an embodiment, as the second main circuit board 462 and the third main circuit board 463 push up the fourth hinge structure 810b, the fourth hinge structure 810b may be folded. According to an embodiment, there may be included another structure in which the connecting member 830 is alternatively/interchangeably connected to the circuit board (e.g., the second main circuit board 462 or third main circuit board 463).

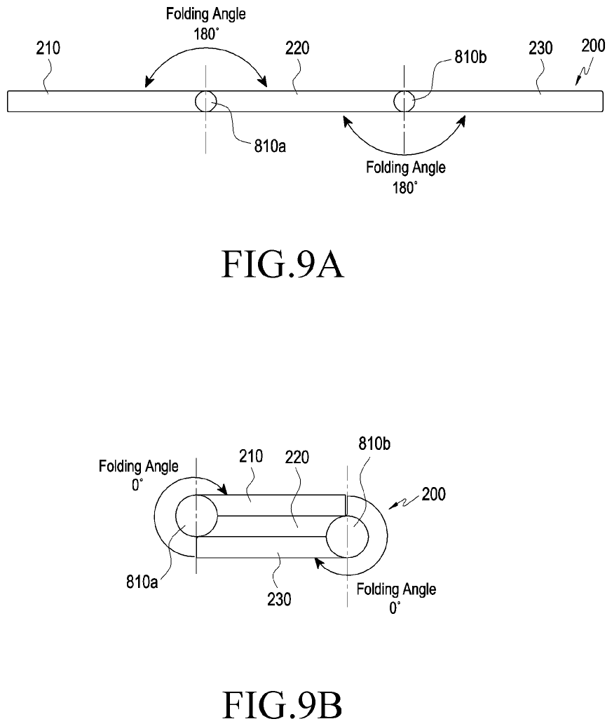

FIGS. 9A and 9B are views illustrating a folding angle according to an embodiment.

Referring to FIG. 9A, according to an embodiment, the foldable housing 200 may include a hinge structure (e.g., the third hinge structure 810a or fourth hinge structure 810b), a first housing structure 210, a second housing structure 220, and a third housing structure 230. FIG. 9A illustrates an example in which the first housing structure 210, second housing structure 220, and third housing structure 230 are in the fully unfolded state. In the disclosure, for ease of description, the folding angle in the fully unfolded state of the first housing structure 210, second housing structure 220, and third housing structure 230 may be defined as 180 degrees. However, this is merely an example. The folding angle in the fully unfolded state of the first housing structure 210, second housing structure 220, and third housing structure 230 may be defined as 0 degrees.

Referring to FIG. 9B, according to an embodiment, the foldable housing 200 may include a hinge structure (e.g., the third hinge structure 810a or fourth hinge structure 810b), a first housing structure 210, a second housing structure 220, and a third housing structure 230. FIG. 9B illustrates an example in which the first housing structure 210, second housing structure 220, and third housing structure 230 are in the fully folded state. In the disclosure, for ease of description, the folding angle in the fully folded state of the first housing structure 210, second housing structure 220, and third housing structure 230 may be defined as 0 degrees. However, this is merely an example. The folding angle in the fully unfolded state of the first housing structure 210, second housing structure 220, and third housing structure 230 may be defined as 180 degrees.

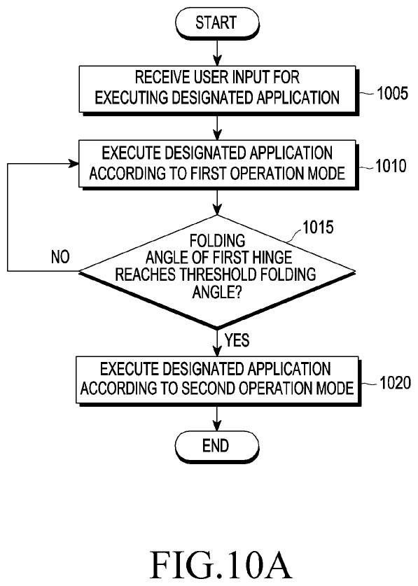

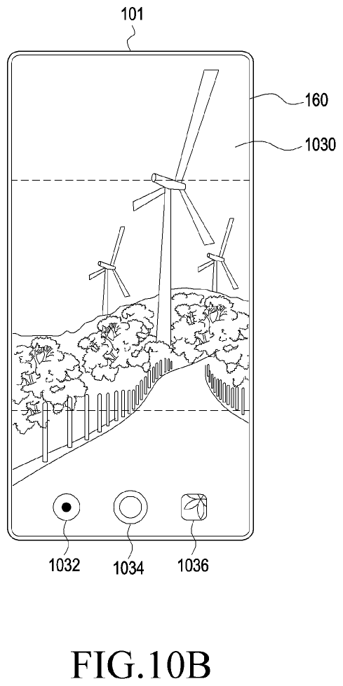

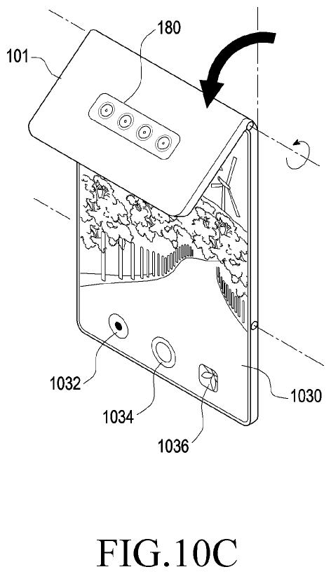

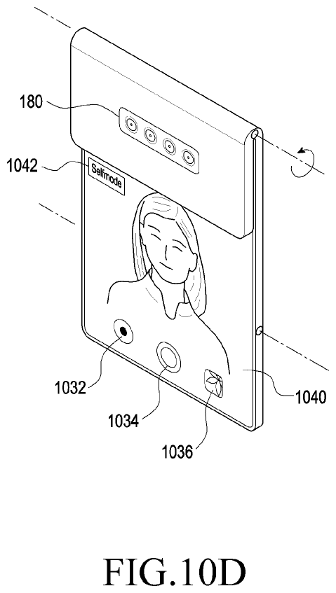

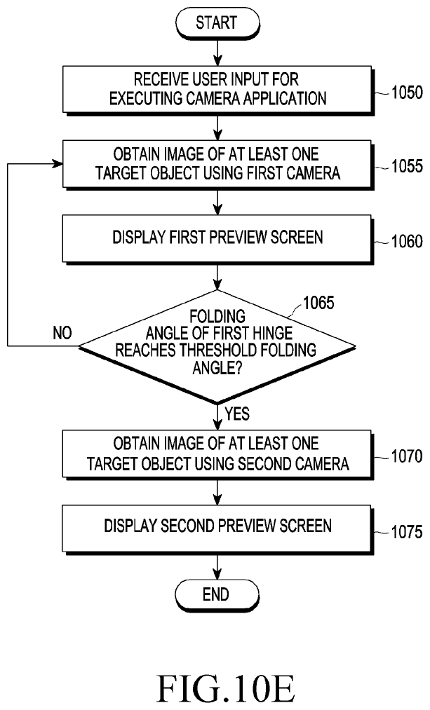

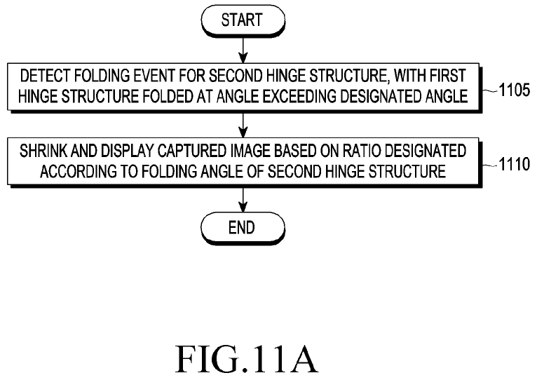

FIGS. 10A, 10B, 10C, and 10D are views illustrating a function or operation of switching an operation mode of a camera application according to first hinge structure (e.g., the first hinge structure 450a of FIG. 4 or the third hinge structure 810a of FIG. 8) folds.

Referring to FIG. 10A, according to an embodiment, an electronic device (e.g., the processor 120 of FIG. 1) may receive a user input for executing a designated application (e.g., a camera application) in operation 1005. According to an embodiment, the user input may include a touch input on a camera application icon.

According to an embodiment, the electronic device (e.g., the processor 120 of FIG. 1) may execute the designated application (e.g., a camera application) according to a first operation mode in operation 1010. According to an embodiment, the first operation mode may include a normal mode (standard mode or default mode) for capturing an object positioned in the same direction as the direction in which the user views. According to an embodiment, the first operation mode may include various operation modes, e.g., a virtual reality (AR) capturing mode, a slow motion capturing mode, or a video recording mode.

According to an embodiment, the electronic device (e.g., the processor 120 of FIG. 1) may identify whether the folding angle of the first hinge structure (e.g., the first hinge structure 450a of FIG. 4) reaches a threshold folding angle in operation 1015. According to an embodiment, the threshold folding angle may be, e.g., 20 degrees, but this is a mere example. According to an embodiment, unless the folding angle of the first hinge structure (e.g., the first hinge structure 450a of FIG. 4) reaches the threshold folding angle (no in operation 1015), the camera application may keep running according to the first operation mode.

According to an embodiment, when the folding angle of the first hinge structure (e.g., the first hinge structure 450a of FIG. 4) reaches the threshold folding angle (yes in operation 1015), the electronic device (e.g., the processor 120 of FIG. 1) may execute the designated application according to a second operation mode in operation 1020. According to an embodiment, the second operation mode may include a mode different from the first operation mode. According to an embodiment, the second operation mode may include a mode for capturing an object positioned in the same direction as the direction in which the electronic device faces the user. For example, the second operation mode may include various capturing modes, such as a selfie mode for capturing the user herself, an augmented reality capturing mode, a landscape (e.g., horizontal to the ground) slow motion capturing mode, or a landscape video recording mode. According to an embodiment, in the selfie mode, a screen different from the first operation mode (e.g., the normal mode) may be provided. For example, in the selfie mode, the electronic device (e.g., the processor 120) may display a graphic interface for applying various visual effects (e.g., a sticker) to the object included in the captured screen (e.g., preview screen), display a graphic interface for transmitting the captured image to other device, display a graphic interface for checking the user's current eye or skin condition, or display at least one of graphic interfaces for identifying the user's health condition based on the current skin color.

Referring to FIG. 10B, according to an embodiment, the electronic device 101 may display a first preview screen 1030 on the display device 160 in the normal mode. FIG. 10B illustrates an example in which the folding angle of the hinge structure (e.g., the first hinge structure 450a or second hinge structure 450b) is 180 degrees according to an embodiment. According to an embodiment, the preview screen may include at least one object captured by the user. According to an embodiment, a first graphic interface 1032 for recording video, a second graphic interface 1034 for capturing still images, and a third graphic interface 1036 for running a designated application (e.g., a gallery application) may be displayed on the first preview screen 1030.

FIGS. 10C and 10D illustrate an example in which the folding angle of the electronic device 101 reaches the threshold folding angle according to an embodiment. According to an embodiment, when the folding angle of the electronic device 101 (e.g., the first hinge structure 450a) reaches the threshold folding angle, the operation mode of the electronic device 101 or camera application may switch. According to an embodiment, as shown in FIG. 10D, as the operation mode of the electronic device 101 or camera application switches, the screen displayed on the electronic device 101 may switch from a first screen (e.g., the first preview screen 1030) to a second preview screen 1040 (e.g., a screen for taking selfie). Referring to FIG. 10D, according to an embodiment, a fourth graphic interface 1042 indicating the current operation mode of the electronic device 101 or camera application may be displayed on the second preview screen 1040. According to an embodiment, the fourth graphic interface 1042 may not be displayed. According to an embodiment, when the operation mode of the electronic device 101 or camera application switches, the currently active camera (e.g., the camera having captured the target object) may remain as it is while the operation mode switches. According to an embodiment, when the operation mode of the electronic device 101 or camera application switches, the currently active camera may switch to another camera (e.g., from a telephoto camera to a standard camera). According to an embodiment, when the capturing direction of the camera is changed, the electronic device (e.g., the processor 120 of FIG. 1) may change the display direction of the preview screen (e.g., the second preview screen 1040) according to the changed camera capturing direction.

FIG. 10E is a view illustrating an example of changing a camera as an example of switching an operation mode of a camera application as a first hinge structure (e.g., the first hinge structure 450a of FIG. 4) folds.

According to an embodiment, the electronic device (e.g., the processor 120 of FIG. 1) may receive a user input for executing a camera application in operation 1050.

According to an embodiment, the electronic device (e.g., the processor 120 of FIG. 1) may obtain an image of at least one target object using a first camera (e.g., the first camera 180a of FIG. 2) in operation 1055.

According to an embodiment, the electronic device (e.g., the processor 120 of FIG. 1) may display a first preview screen in operation 1060. In operation 1060, according to an embodiment, the first preview screen may include a preview screen including an image of at least one target object using the first camera.

According to an embodiment, the electronic device (e.g., the processor 120 of FIG. 1) may identify whether the folding angle of the first hinge structure (e.g., the first hinge structure 450a of FIG. 4) reaches a threshold folding angle in operation 1065. According to an embodiment, the threshold folding angle may be, e.g., 20 degrees, but this is a mere example. According to an embodiment, unless the folding angle of the first hinge structure (e.g., the first hinge structure 450a of FIG. 4) reaches the threshold folding angle (no in operation 1065), the first preview screen may keep being displayed.

According to an embodiment, when the folding angle of the first hinge structure (e.g., the first hinge structure 450a of FIG. 4) is identified to reach the threshold folding angle (yes in operation 1065), the electronic device (e.g., the processor 120 of FIG. 1) may obtain an image of at least one target object using a second camera (e.g., the second camera 180b of FIG. 2) in operation 1070.

According to an embodiment, the electronic device (e.g., the processor 120 of FIG. 1) may display a second preview screen in operation 1075. In operation 1075, according to an embodiment, the second preview screen may include a screen including an image of at least one target object using the second camera. According to an embodiment, the angle of view of the preview screen may be varied depending on variations in the folding angle of the electronic device 101. Thus, when the folding angle is identified to reach the threshold angle, the electronic device (e.g., the processor 120 of FIG. 1) may change the camera for capturing the target object (e.g., from the first camera to the second camera) so as to provide a seamless preview screen to the user.

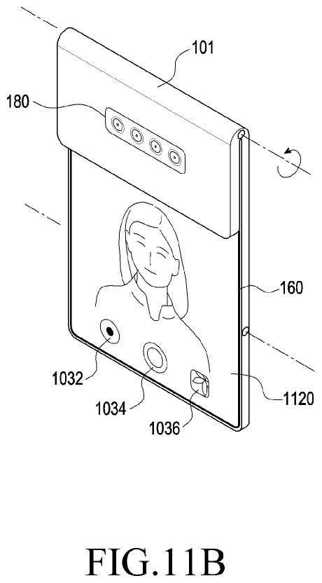

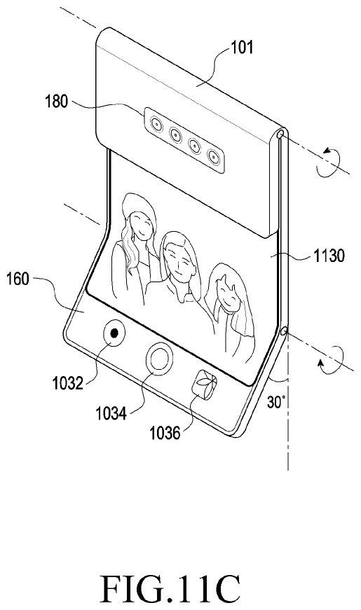

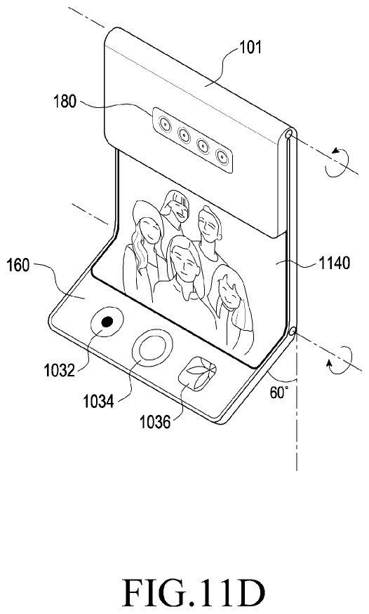

FIGS. 11A, 11B, 11C, and 11D are views illustrating a function or operation of shrinking a display area where a screen is displayed when a folding event on a second hinge structure (e.g., the second hinge structure 450b of FIG. 4) occurs, with a first hinge structure (e.g., the first hinge structure 450a of FIG. 4) folded.

Referring to FIG. 11A, according to an embodiment, the electronic device (e.g., the processor 120 of FIG. 1) may detect a folding event on the second hinge structure (e.g., the second hinge structure 450b of FIG. 4), with the first hinge structure (e.g., the first hinge structure 450a of FIG. 4) folded at an angle exceeding a designated angle (e.g., 20 degrees) in operation 1105.

According to an embodiment, the electronic device (e.g., the processor 120 of FIG. 1) may shrink and display the captured image based on a designated ratio according to the folding angle of the second hinge structure (e.g., the second hinge structure 450b of FIG. 4), in operation 1110.

Referring to FIG. 11B, according to an embodiment, the electronic device 101 may display the third preview screen 1120 on the display device 160, with the first hinge structure (e.g., the first hinge structure 450a of FIG. 4) folded at an angle exceeding the designated angle. According to an embodiment, the electronic device 101 may display the third preview screen 1120 in the area (e.g., the preview screen display area) marked with the bold line in FIG. 11B. According to an embodiment, the third preview screen 1120 may not be displayed in the area covered by the first housing structure (e.g., the first housing structure 210 of FIG. 1). The bold line in FIG. 11B is provided for ease of description and is not actually displayed.

Referring to FIG. 11C, according to an embodiment, the electronic device 101 may detect a folding event on the second hinge structure (e.g., the second hinge structure 450b of FIG. 4). According to an embodiment, the folding event may be detected based on a variation in the folding angle of the second hinge structure detected by the angle sensor. FIG. 11C illustrates an example in which the electronic device 101 is folded at a designated angle (e.g., 30 degrees) with respect to the fully unfolded state of the electronic device 101 (e.g., when the folding angle is 150 degrees). According to an embodiment, as the folding event occurs on the second hinge structure (e.g., the second hinge structure 450b of FIG. 4), the electronic device 101 may shrink the area where the third preview screen 1120 is displayed according to a designated ratio. According to an embodiment, the electronic device 101 may shrink and display the screen based on information (e.g., a mapping table) that defines the relationship between folding angle and size of screen (e.g., preview screen). According to an embodiment, the electronic device 101 may display a fourth preview screen 1130 which is the third preview screen 1120 shrunken in the designated ratio on the display device 160. According to an embodiment, the fourth preview screen 1130 may include the screen shrunken in the designated ratio from the third preview screen 1120. In other words, according to an embodiment, the electronic device 101 may shrink the preview screen while decreasing the magnification of the screen, and display the same. According to an embodiment, the electronic device 101 may shrink the area where the screen is displayed while maintaining the magnification of the screen. According to an embodiment, the electronic device 101 may display various graphic interfaces (e.g., the first graphic interface 1032, the second graphic interface 1034, and the third graphic interface 1036) in the area where the preview screen (e.g., the fourth preview screen 1130) is not displayed. According to an embodiment, as the magnification increases or decreases, the number or size of objects included in the preview screen may be varied (e.g., when the magnification reduces, the number of objects in the preview screen may increase and the size of objects may reduce). In the disclosure, the term of “increasing magnification” may be replaced with the term “zooming-in” or “reducing angle of view.” In the disclosure, the term of “decreasing magnification” may be replaced with the term “zooming-out” or “increasing angle of view.”

Referring to FIG. 11D, according to an embodiment, the electronic device 101 may detect a folding event with the fourth preview screen 1130 displayed. FIG. 11D illustrates an example in which the electronic device 101 turns from fully unfolded to 60-degree folded (e.g., when the folding angle is 120 degrees). According to an embodiment, the electronic device 101 may display, on the display device 160, a fifth preview screen 1140 reduced in at least one of size and magnification from the fourth preview screen 1130 based on information (e.g., the mapping table) in which folding angles and screen (e.g., preview screen) shrinking ratios are defined. According to an embodiment, if the folding angle reaches a designated angle, the preview screen (e.g., the fifth preview screen 1140) may be displayed on the display device 160 in such a manner as to change the camera for capturing a specific object. In this case, according to an embodiment, the electronic device 101 may switch cameras based on the information (e.g., mapping table) in which the relationship between folding angle and time of switching cameras is defined. According to an embodiment, the electronic device 101 may display at least one graphic interface (e.g., the first graphic interface 1032, the second graphic interface 1034, and the third graphic interface 1036) in the area where the preview screen (e.g., the fifth preview screen 1140) is not displayed. Although FIGS. 11C and 11D illustrate an example in which the magnification of preview screen is reduced as a folding event occurs, according to an embodiment, the preview screen may be displayed on the display device 160 so that the magnification of the preview screen increases as a folding event occurs.

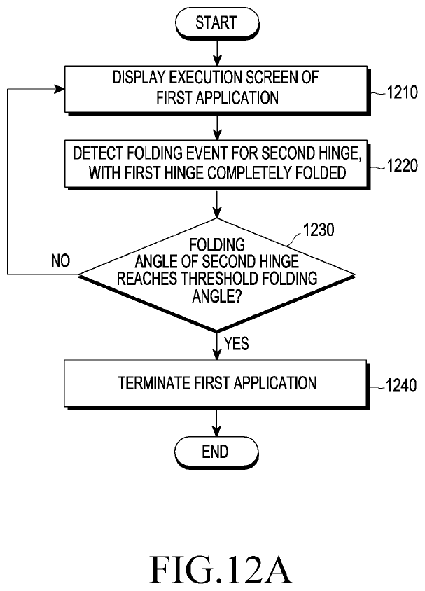

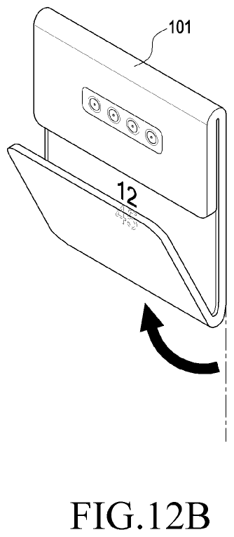

FIGS. 12A and 12B are views illustrating a function or operation of terminating an application being executed when a folding event occurs on a second hinge structure (e.g., the second hinge structure 450b of FIG. 4), with a first hinge structure (e.g., the first hinge structure 450a of FIG. 4) folded.

Referring to FIG. 12A, according to an embodiment, the electronic device (e.g., the processor 120 of FIG. 1) may display an execution screen of a first application in operation 1210.

According to an embodiment, the electronic device (e.g., the processor 120 of FIG. 1) may detect a folding event on the first hinge structure (e.g., the first hinge structure 450a of FIG. 4) in operation 1220.

According to an embodiment, the electronic device (e.g., the processor 120 of FIG. 1) may identify whether the folding angle of the first hinge structure (e.g., the first hinge structure 450a of FIG. 4) reaches a threshold folding angle in operation 1230. According to an embodiment, the threshold folding angle may be, e.g., 20 degrees. In other words, if the electronic device 101 is folded at 160 degrees with respect to the fully unfolded state (e.g., when the folding angle is 20 degrees), the electronic device 101 may identify that it has reached the threshold folding angle.

According to an embodiment, when the folding angle of the first hinge structure (e.g., the first hinge structure 450a of FIG. 4) reaches the threshold folding angle (yes in operation 1230), the electronic device (e.g., the processor 120 of FIG. 1) may terminate the first application being executed in operation 1240. Referring to FIG. 12B, according to an embodiment, if a specific hinge structure (e.g., the first hinge structure (e.g., the first hinge structure 450a of FIG. 4)) is in the fully folded state, and the folding angle of another hinge structure (e.g., the second hinge structure (e.g., the second hinge structure 450b of FIG. 4)) reaches the threshold folding angle, the electronic device (e.g., the processor 120 of FIG. 1) may terminate the first application being executed and display the home screen on the display device 160.

According to an embodiment, unless the folding angle of the first hinge structure (e.g., the first hinge structure 450a of FIG. 4) reaches the threshold folding angle (no in operation 1230), the electronic device 101 may keep on displaying the execution screen of the first application.

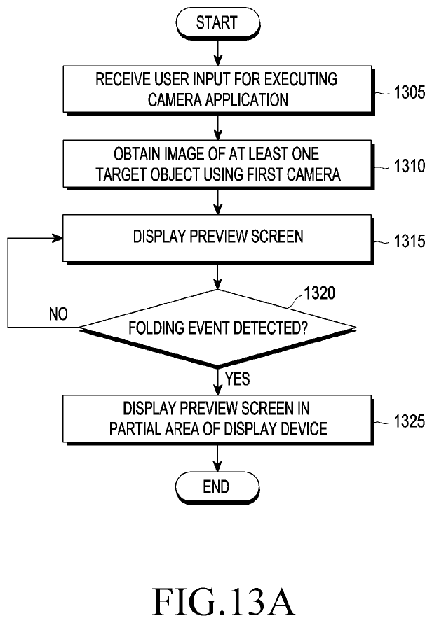

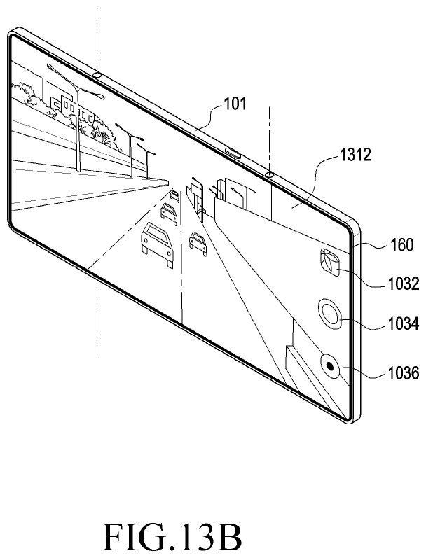

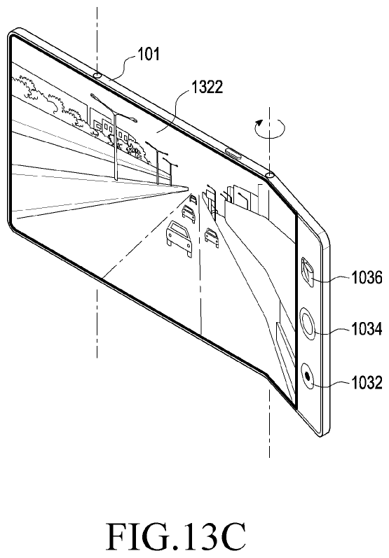

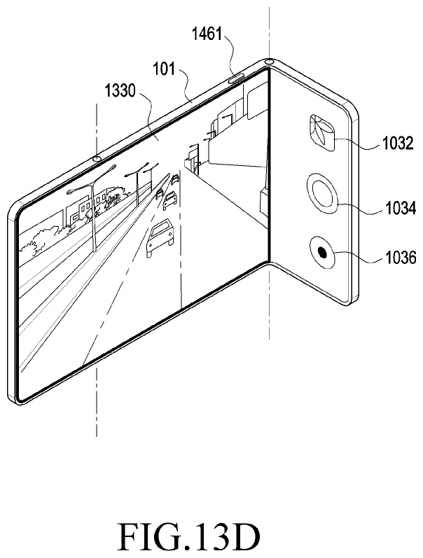

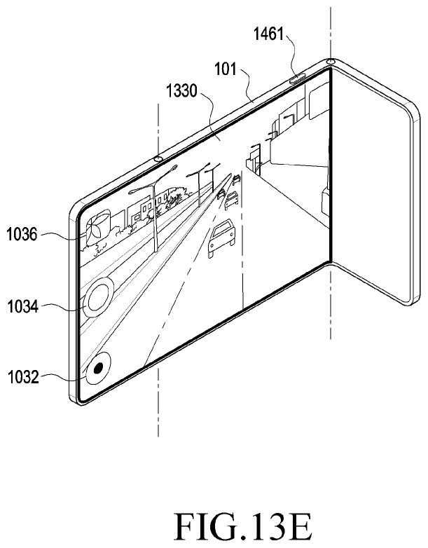

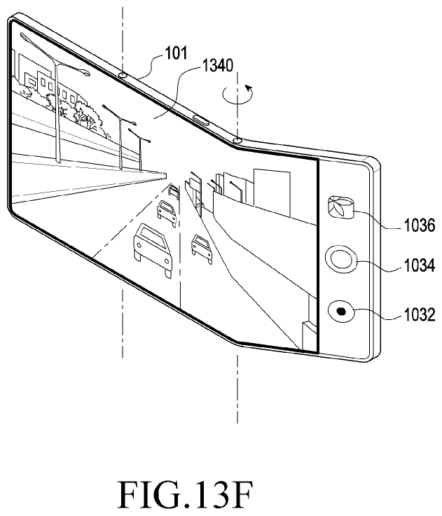

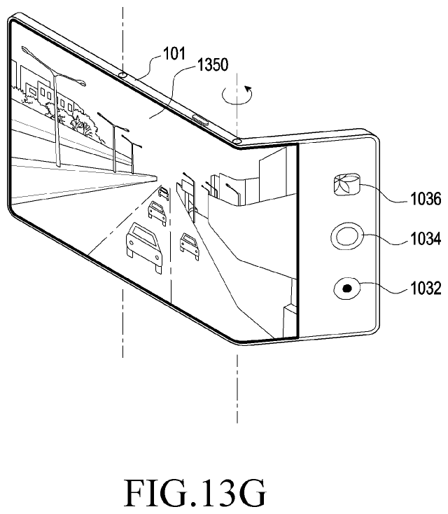

FIGS. 13A, 13B, 13C, 13D, 13E, and 13F are views illustrating a function or operation of shrinking a display area where a screen is displayed when a folding event on a second hinge structure (e.g., the second hinge structure 450b of FIG. 4 or the fourth hinge structure 810b of FIG. 8), with a first hinge structure (e.g., the first hinge structure 450a of FIG. 4 or the third hinge structure 810a of FIG. 8) unfolded.

Referring to FIG. 13A, according to an embodiment, the electronic device (e.g., the processor 120 of FIG. 1) may receive a user input for executing a camera application in operation 1305.

According to an embodiment, the electronic device (e.g., the processor 120 of FIG. 1) may obtain an image for at least one target object using a first camera in operation 1310.

According to an embodiment, the electronic device (e.g., the processor 120 of FIG. 1) may display a preview screen in operation 1315. According to an embodiment, the preview screen may include a screen including an image of at least one target object using the first camera (e.g., the first camera 180a of FIG. 2).

According to an embodiment, the electronic device (e.g., the processor 120 of FIG. 1) may identify whether a folding event is detected in operation 1320.

According to an embodiment, upon identifying that a folding event is detected (yes in operation 1320), the electronic device (e.g., the processor 120 of FIG. 1) may display a preview screen on a partial area of the display device in operation 1325 (e.g., the display device 160 of FIG. 1). According to an embodiment, if no folding event occurs (no in operation 1320), the electronic device (e.g., the processor 120 of FIG. 1) may keep on displaying the preview screen.

Referring to FIG. 13B, according to an embodiment, the electronic device 101 may display a screen (e.g., the sixth preview screen 1312) on the display device 160 in the fully unfolded state. According to an embodiment, the electronic device 101 may display at least one graphic interface (e.g., the first graphic interface 1032, the second graphic interface 1034, and the third graphic interface 1036) on the sixth preview screen 1312. In FIG. 13B, for ease of description, the area where the preview screen (e.g., the sixth preview screen 1312) is displayed is denoted with a bold line. According to an embodiment, the bold line for denoting the display area may be a virtual line shown for illustration purposes and is not actually displayed on the display device 160.

Referring to FIG. 13C, according to an embodiment, upon detecting a folding event on the second hinge structure (e.g., the hinge structure 450b of FIG. 4), the electronic device 101 may display a seventh preview screen 1322 shrunken from the sixth preview screen 1312 according to a designated ratio on the display device 160. According to an embodiment, the electronic device 101 may shrink and display the screen (e.g., the sixth preview screen 1312) on the display device 160 based on information (e.g., a mapping table) that defines the relationship between folding angle and size of screen (e.g., preview screen). According to an embodiment, the size of the graphic interface (e.g., the first graphic interface 1032, second graphic interface 1034, or third graphic interface 1036) may be maintained, increased, or decreased depending on a variation (e.g., reduction) in the folding angle.

Referring to FIG. 13D, according to an embodiment, upon detecting a folding event (e.g., when the folding angle is 90 degrees) on the second hinge structure (e.g., the hinge structure 450b of FIG. 4), the electronic device 101 may display an eighth preview screen 1330 shrunken from the seventh preview screen 1322 according to a designated ratio on the display device 160. According to an embodiment, the center of the screen may be shifted to meet the center of the display area as the screen is shrunken. According to an embodiment, if the folding angle reaches a designated angle (e.g., 90 degrees), the electronic device 101 may display the screen (e.g., the eighth preview screen 1330) in a first area (e.g., the first area 201 and second area 202 of FIG. 2) of the display device 160. FIGS. 13B to 13D illustrate an example in which the size of preview screen is adjusted (e.g., reduced) as the folding event occurs. However, according to an embodiment, as a folding event occurs, the magnification of screen may be adjusted (e.g., increased or reduced) as the size of the preview screen is adjusted (e.g., reduced or increased). According to an embodiment, if the third housing structure (e.g., the third housing structure 230 of FIG. 2) fully covers the second housing structure (e.g., the second housing structure 220 of FIG. 2), the preview screen may be displayed in a portion of the first area (e.g., the first area 201 of FIG. 2) and second area (e.g., the second area 202) of the display device 160. According to an embodiment, if the folding angle reaches a designated angle (e.g., 90 degrees), at least one graphic interface (e.g., the first graphic interface 1032, the position in which the second graphic interface 1034, and/or third graphic interface 1036) is displayed may be changed as shown in FIG. 13E. According to an embodiment, if the folding angle reaches a designated angle (e.g., 90 degrees), at least some of functions performed on the at least one graphic interface (e.g., the first graphic interface 1032, second graphic interface 1034, and/or third graphic interface 1036) may be performed by pressing a physical key (e.g., the button 1416).

Referring to FIGS. 13F and 13G, according to an embodiment, the electronic device 101 may detect a folding event on the second hinge structure (e.g., the fourth hinge structure 810b of FIG. 8). According to an embodiment, upon detecting the folding event, the electronic device 101 may display a screen (e.g., a ninth preview screen 1340 or tenth preview screen 1350) shrunken further than the screen displayed on the display device 160 in the fully unfolded state of the electronic device 101. According to an embodiment, the size of the area where the ninth preview screen 1340 is displayed on the display device 160 may be larger than the size of the area where the tenth preview screen 1350 is displayed on the display device 160. In FIGS. 13B to 13G, for ease of description, the area where the screen (e.g., the preview screen) is displayed is denoted with a bold line. The bold line is shown for illustration purposes, and is not indeed displayed on the screen (e.g., the preview screen). FIGS. 13F and 13G illustrate an example in which the size of preview screen is adjusted (e.g., reduced) as the folding event occurs. However, according to an embodiment, as a folding event occurs, the magnification of screen may be adjusted (e.g., increased or reduced) as the size of the preview screen is adjusted (e.g., reduced or increased).

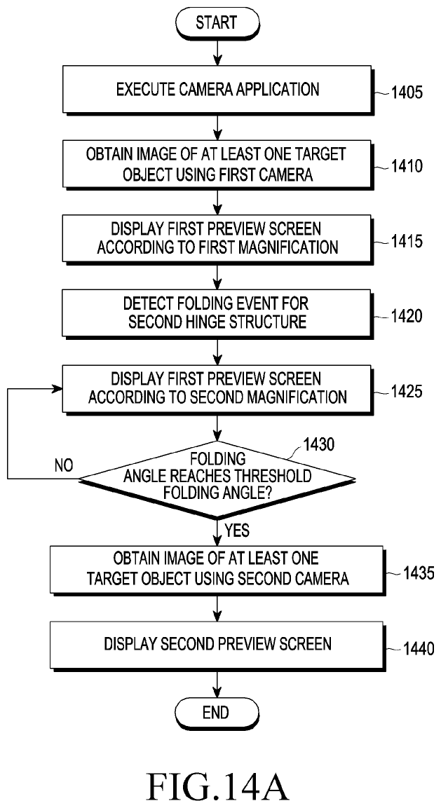

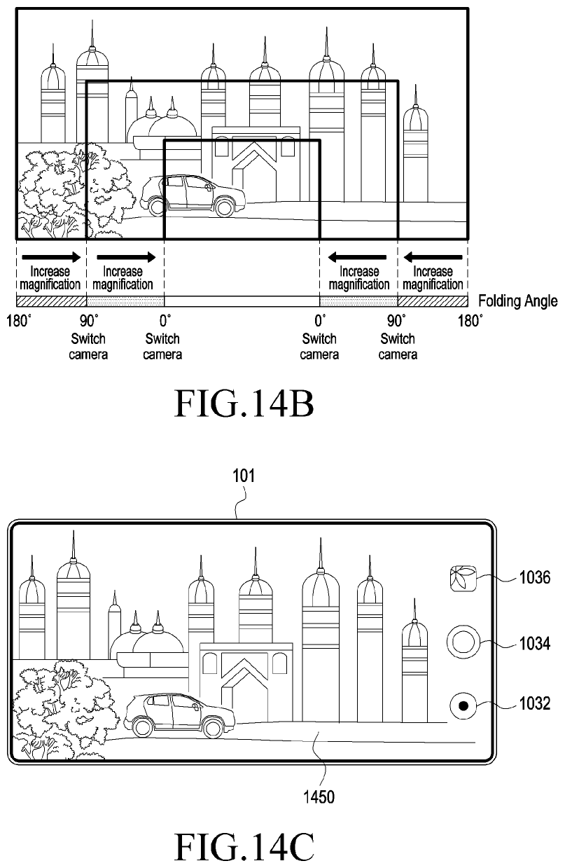

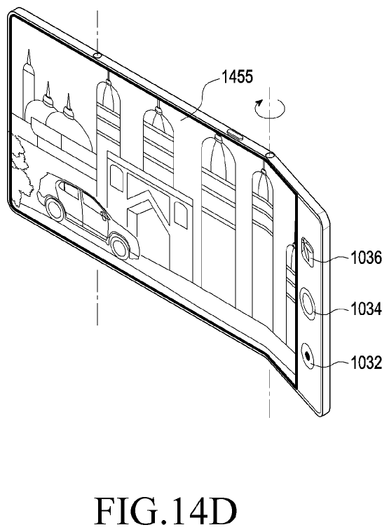

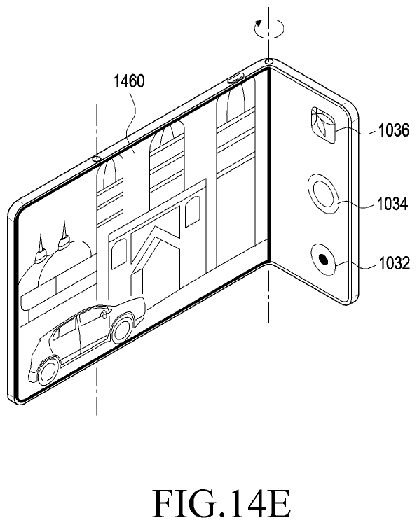

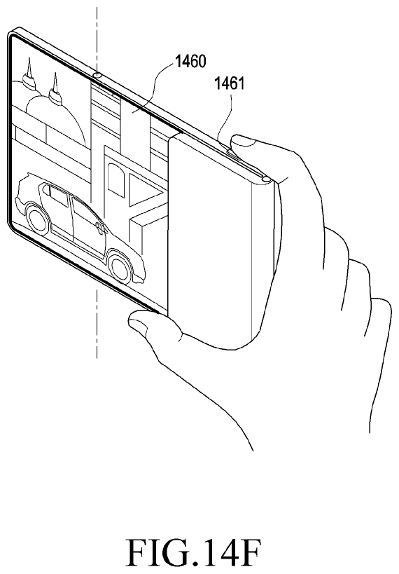

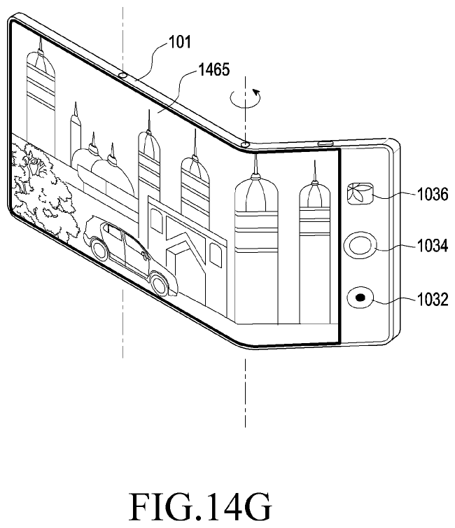

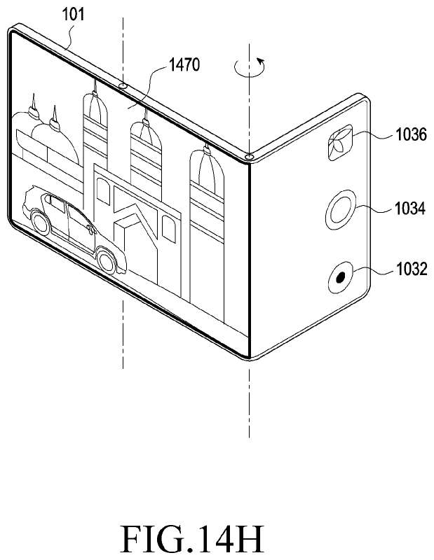

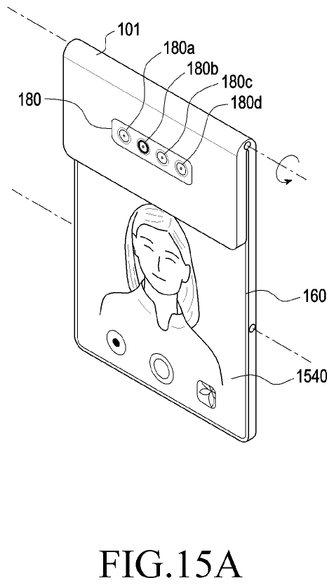

FIGS. 14A, 14B, 14C, 14D, 14E, 14F, 14G, and 14H are views illustrating a function or operation of continuously (e.g., seamlessly) switching screens when a folding event on a second hinge structure (e.g., the second hinge structure 450b of FIG. 4 or the fourth hinge structure 810b of FIG. 8) occurs, with a first hinge structure (e.g., the first hinge structure 450a of FIG. 4 or the third hinge structure 810a of FIG. 8) unfolded.

Referring to FIG. 14A, according to an embodiment, an electronic device (e.g., the processor 120 of FIG. 1) may execute a camera application in operation 1405.

According to an embodiment, the electronic device (e.g., the processor 120 of FIG. 1) may obtain an image for at least one target object using a first camera in operation 1410. According to an embodiment, the first camera may include, e.g., a wide-angle camera (e.g., the first camera 180a of FIG. 2).

According to an embodiment, the electronic device (e.g., the processor 120 of FIG. 1) may display a preview screen according to a first magnification in operation 1415. According to an embodiment, the first magnification may be a magnification (e.g., one time) predesignated as initial value for the first camera 180a. According to an embodiment, the first preview screen in operation 1415 may include a preview screen including a target object image obtained using the first camera (e.g., the first camera 180a of FIG. 2).

According to an embodiment, the electronic device (e.g., the processor 120 of FIG. 1) may detect a folding event on the second hinge structure (e.g., the second hinge structure 450b of FIG. 2 or the fourth hinge structure 810b of FIG. 8) in operation 1420. According to an embodiment, the folding event may be detected (or identified) by the electronic device (e.g., the processor 120 of FIG. 1) based on the angle detected by the angle sensor.

According to an embodiment, the electronic device (e.g., the processor 120 of FIG. 1) may display the preview screen according to the second magnification on the display device 160, based on detection of the folding event in operation 1425. According to an embodiment, an example relationship between folding angle and second magnification is shown in Table 1 below.

TABLE 1

| folding angle (°) | second magnification (times) |
|---|---|
| 180 | 1.00 (first camera) |
| (when fully unfolded) | |
| 179 | 1.01 (first camera) |
| 178 | 1.02 (first camera) |
| 177 | 1.03 (first camera) |
| 176 | 1.04 (first camera) |
| 175 | 1.05 (first camera) |
| 174 | 1.06 (first camera) |
| 173 | 1.07 (first camera) |
| 172 | 1.08 (first camera) |
| 171 | 1.09 (first camera) |
| 170 | 1.10 (first camera) |
| . . . | . . . |
| 90 | 1.90 (first camera)/ |
| | 1.00 (third camera) |
| 89 | 1.01 (third camera) |
| 88 | 1.02 (third camera) |
| 87 | 1.03 (third camera) |
| . . . | . . . |
| 0 | 1.00 (second camera) |
| (when fully folded) | |

According to an embodiment, by the nature of foldable devices, the user may use the electronic device 101 more frequently when fully unfolded, folded at 90 degrees, or fully folded than in other cases. Thus, a screen (e.g., default screen) with a 1× (one-times) magnification for each camera at 180 degrees, 90 degrees, and 0 degrees may be displayed to provide the sharpest screen in such cases. According to an embodiment, screen upscaling technology may be applied during the course of changing the magnification.

According to an embodiment, upon detecting the folding event on the second hinge structure (e.g., the second hinge structure 450b of FIG. 4 or the fourth hinge structure 810b of FIG. 8) in operation 1425, a continuous (e.g., seamless) screen switch may be possible. According to an embodiment, upon detecting the folding event on the second hinge structure (e.g., the second hinge structure 450b of FIG. 4 or the fourth hinge structure 810b of FIG. 8), the area where the screen is displayed may be reduced while increasing the magnification of the screen (e.g., the preview screen including an image of at least one target object).

According to an embodiment, the electronic device (e.g., the processor 120 of FIG. 1) may identify whether the folding angle reaches the threshold folding angle in operation 1430. According to an embodiment, the threshold folding angle may include an angle at which, for example, the screen in which the first preview image is magnified at a designated magnification becomes identical to the second preview screen (e.g., the preview screen when the magnification of the second camera (e.g., the third camera 180c of FIG. 2) is x1.0). This is described with reference to Table 1. Since the case where “1.90 times” as the magnification of the first preview screen becomes identical the magnification (1.00 times) of the image (e.g., the third camera 180c) first obtained by the second camera (e.g., the third camera 180c of FIG. 2) at a folding angle of 90 degrees, the folding angle “90 degrees” may be identified (e.g., determined) as the threshold folding angle by the electronic device (e.g., the processor 120 of FIG. 1). According to an embodiment, the threshold folding angle (e.g., 90 degrees) may be predetermined. In this case, according to an embodiment, the electronic device (e.g., the processor 120 of FIG. 1) may seamlessly switch preview screens using one camera without simultaneously activating the plurality of cameras (in other words, without activating the second camera at a specific time).

According to an embodiment, the electronic device (e.g., the processor 120 of FIG. 1) may activate all of the two cameras (e.g., the first camera (e.g., the first camera 180a of FIG. 2)) and the second camera (e.g., the third camera 180c of FIG. 2) (e.g., capturing using all of the two cameras) at a specific time (e.g., the time when the first preview screen is displayed at the default magnification) so as to identify the threshold folding angle. Thus, according to an embodiment, the electronic device (e.g., the processor 120 of FIG. 1) may identify the time when the screens objected via the different cameras become identical (e.g., the threshold folding angle).

According to an embodiment, upon identifying that the folding angle reaches the threshold folding angle (yes in operation 1430), the electronic device (e.g., the processor 120 of FIG. 1) may object an image of at least one target object using the second camera in operation 1435. According to an embodiment, the electronic device (e.g., the processor 120 of FIG. 1) may provide seamless screens using various techniques, e.g., image stitching, for seamless screen display despite switching cameras for capturing objects. According to an embodiment, upon identifying that the folding angle does not reach the threshold folding angle (no in operation 1430), the electronic device (e.g., the processor 120 of FIG. 1) may keep on displaying the first preview screen according to the second magnification.

According to an embodiment, the electronic device (e.g., the processor 120 of FIG. 1) may display a second preview screen in operation 1440. According to an embodiment, in operation 1440, the second preview screen may include a preview screen including an image for at least one target object objected using the second camera (e.g., the third camera 180c of FIG. 2).

Referring to FIG. 14B, according to an embodiment, the electronic device (e.g., the electronic device 101 of FIG. 1) may increase the magnification of the preview screen as the folding angle reduces (e.g., as the second hinge structure (e.g., the second hinge structure 450b of FIG. 4 or the fourth hinge structure 810b of FIG. 8) folds). According to an embodiment, when the folding angle reaches the threshold folding angle (e.g., when the screen objected by the first camera (e.g., the first camera 180a of FIG. 2) becomes identical to the screen first obtained by the other camera (e.g., the third camera 180c of FIG. 2)), the electronic device (e.g., the electronic device 101 of FIG. 1) may switch the camera (e.g., from the first camera 180a to the third camera 180c). An example has been described above in connection with FIG. 14B where the threshold folding angles for switching cameras are 90 degrees (e.g., switching from the first camera 180a to the third camera 180c) and 0 degrees (e.g., when fully folded) (e.g., switching from the third camera 180c to the second camera 180b).

Referring to FIG. 14C, according to an embodiment, the electronic device 101 may display a screen (e.g., an eleventh preview screen 1450) including at least one target object in the fully unfolded state of the electronic device 101. FIG. 14C illustrates an example in which a preview screen is provided via the first camera (e.g., the first camera 180a FIG. 2).

Referring to FIG. 14D, according to an embodiment, the electronic device 101 may display a twelfth preview screen 1455 magnified in a designated ratio further than the eleventh preview screen 1450 according to detection of a folding event on the second hinge structure (e.g., the second hinge structure 450b of FIG. 4). FIG. 14D illustrates an example in which the angle varied by the folding event does not reach the threshold folding angle and thus the object obtained by the first camera 180a is provided as a preview screen. In FIG. 14D, the area where the object captured by the user is displayed is shown in a bold line for ease of description. As shown in FIG. 14D, the area where the preview screen is displayed may be shrunken according to detection of a folding event. According to an embodiment, in an area other than the area defined in the bold line, at least one graphic interface (e.g., the first graphic interface 1032, the second graphic interface 1034, and the third graphic interface 1036) may be displayed.

Referring to FIGS. 14E and 14F, according to an embodiment, the electronic device 101 may detect a folding event in which the folding angle becomes 90 degrees (e.g., the threshold folding angle). According to an embodiment, the electronic device 101 may display, on the display device 160, a thirteenth preview screen 1460 reduced in size and increased in magnification as compared with the twelfth preview screen 1455 as the folding event occurs. According to an embodiment, as the folding angle reaches 90 degrees, the electronic device 101 may switch the camera (e.g., from the first camera 180a to the third camera 180c) and object an image of the target object. According to an embodiment, the electronic device 101 may shift the center of the preview screen to meet the center of the display area (e.g., the area defined in the bold line) while shrinking the screen. According to an embodiment, if the folding angle becomes less than 90 degrees (e.g., when the second hinge structure 450b is fully folded), the user may capture the target object via an input on a button 1461 provided on one side surface of the electronic device 101 as shown in FIG. 14F.

Referring to FIGS. 14G and 14H, according to an embodiment, the electronic device 101 may detect a folding event on the second hinge structure (e.g., the fourth hinge structure 810b of FIG. 8). According to an embodiment, the electronic device 101 may provide a screen in which the preview screen (e.g., the fourteenth preview screen 1465) continuously reduces in size while increasing in magnification according to detection of the folding event. In FIG. 14D, the area where the object captured by the user is displayed is shown in a bold line for ease of description. As shown in FIG. 14G, the area 1465 where the object captured by the user is displayed according to detection of the folding event may be shrunken as compared with the eleventh preview screen 1450. According to an embodiment, in an area other than the area defined in the bold line, at least one graphic interface (e.g., the first graphic interface 1032, the second graphic interface 1034, and the third graphic interface 1036) may be displayed. Referring to FIG. 14H, a fifteenth preview screen 1470 in which the area where the object captured by the user is displayed is shrunken as compared with the fourteenth preview screen 1465 may be displayed on the display device 160 according to detection of the folding event. According to an embodiment, the fifteenth preview screen 1470 may be one for when the folding angle exceeds the threshold folding angle and may include at least one target object captured by a camera (e.g., the second camera 180b of FIG. 2) different from the camera that has captured the twelfth preview screen 1455.

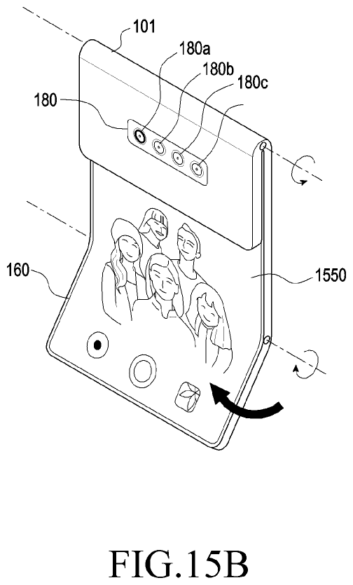

FIGS. 15A and 15B are views illustrating a function or operation of continuously (e.g., seamlessly) switching screens when a folding event occurs on a second hinge structure (e.g., the second hinge structure 450b of FIG. 4), with a first hinge structure (e.g., the first hinge structure 450a of FIG. 4) folded.

Referring to FIGS. 15A and 15B, according to an embodiment, when the first hinge structure is fully folded, the electronic device 101 may display, on the display device 160, a preview screen (e.g., a sixteenth preview screen 1540) including at least one object obtained using the second camera (e.g., the second camera 180b of FIG. 2). According to an embodiment, upon detecting a folding event on the second hinge structure (e.g., the second hinge structure 450b of FIG. 4), the electronic device 101 may switch cameras (e.g., from the second camera (e.g., the second camera 180b of FIG. 2)) to the first camera (e.g., the first camera 180a of FIG. 1) while continuously varying the magnification and size of the preview screen. According to an embodiment, the electronic device may display, on the display device 160, a preview screen (e.g., a seventeenth preview screen 1550) including at least one object obtained via the switched camera (e.g., the first camera (e.g., the first camera 180a of FIG. 1)).

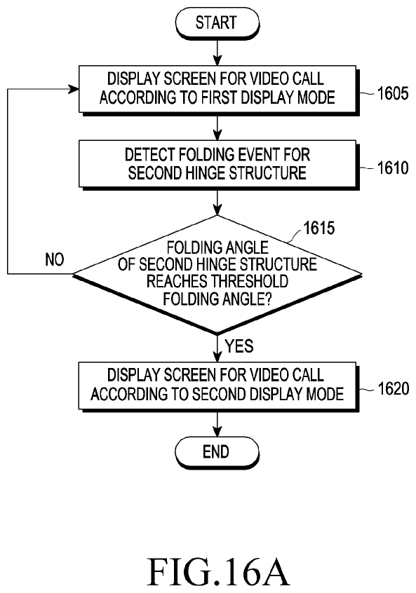

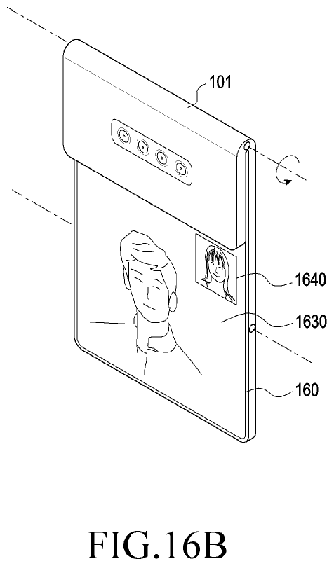

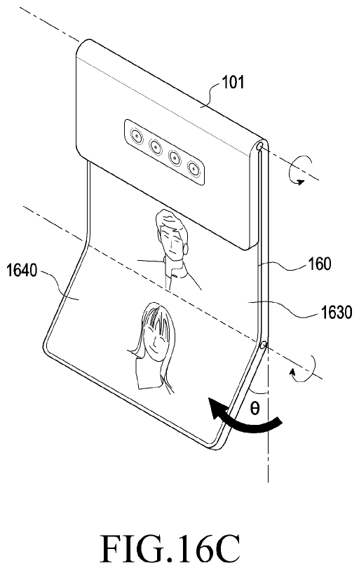

FIGS. 16A, 16B, and 16C are views illustrating a function or operation of switching the screen being displayed on an electronic device (e.g., the electronic device 101 of FIG. 1) when a folding event occurs on a second hinge structure.

Referring to FIG. 16A, according to an embodiment, the electronic device (e.g., the processor 120 of FIG. 1) may display a screen for video call according to a first display mode in operation 1605. According to an embodiment, the first display mode may include a mode in which a screen 1630 for the caller of the video call and a screen 1640 for the recipient of the video call are displayed on a single screen in a picture-in-picture (PIP) manner as shown in FIG. 16B.

According to an embodiment, the electronic device (e.g., the processor 120 of FIG. 1) may detect a folding event on the second hinge structure (e.g., the second hinge structure 450b of FIG. 4) in operation 1610.

According to an embodiment, the electronic device (e.g., the processor 120 of FIG. 1) may identify whether the folding angle of the second hinge structure reaches the threshold folding angle in operation 1615. According to an embodiment, the threshold folding angle (e.g., a folding angle of 150 degrees) may include a reference angle for displaying a screen for video call according to a second display mode. According to an embodiment, the second display mode may include a mode in which a screen 1630 for the caller of the video call and a screen 1640 for the recipient of the video call are displayed separately in a split view manner as shown in FIG. 16C.

According to an embodiment, the electronic device (e.g., the processor 120 of FIG. 1) may display a screen for video call according to the second display mode if the folding angle of the second hinge structure reaches the threshold folding angle (yes in operation 1615), in operation 1620. According to an embodiment, unless the folding angle of the second hinge structure reaches the threshold folding angle (no in operation 1615), the screen for video call may be displayed according to the first display mode. According to an embodiment, when the folding angle of a certain specific hinge structure (e.g., the second hinge structure (e.g., the second hinge structure 450b of FIG. 4)) becomes 0 degrees (e.g., when fully folded), the electronic device 101 may terminate the video call.

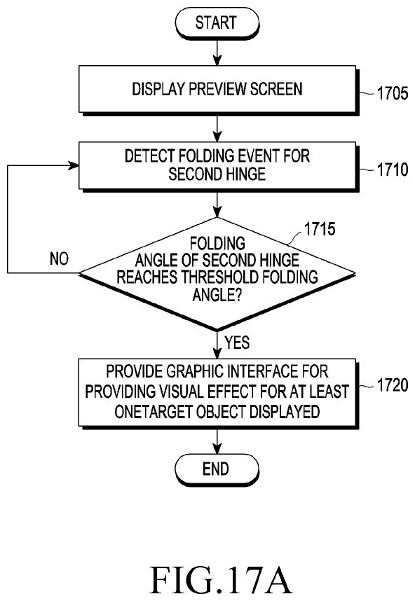

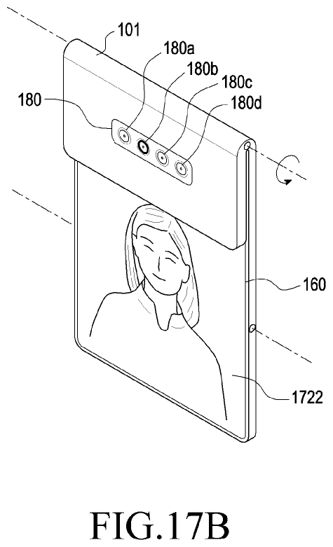

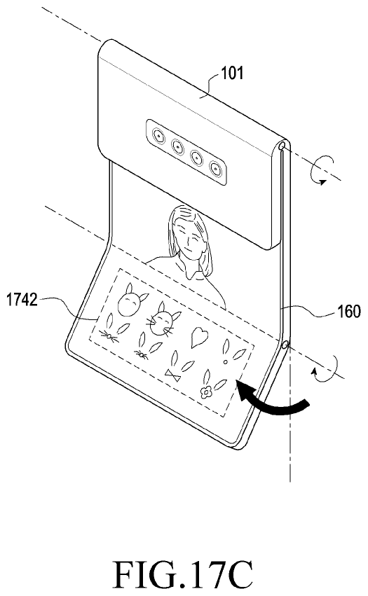

FIGS. 17A, 17B, and 17C are views illustrating a function or operation of providing a designated graphic interface for applying a visual effect to an object being displayed on an electronic device 101 when a folding event occurs on a second hinge structure (e.g., the second hinge structure 450b of FIG. 4).

Referring to FIG. 17A, according to an embodiment, the electronic device (e.g., the processor 120 of FIG. 1) may display a preview screen (e.g., an eighth preview screen 1722), as shown in FIG. 17B, in operation 1705.

According to an embodiment, the electronic device (e.g., the processor 120 of FIG. 1) may detect a folding event on the second hinge structure (e.g., the second hinge structure 450b of FIG. 4) in operation 1710.

According to an embodiment, the electronic device (e.g., the processor 120 of FIG. 1) may identify whether the folding angle of the second hinge structure (e.g., the second hinge structure 450b of FIG. 4) reaches a threshold folding angle in operation 1715. According to an embodiment, the threshold folding angle may include a reference angle for providing a designated graphic interface for applying a visual effect to the object being displayed on the electronic device 101. According to an embodiment, the designated graphic interface for applying the visual effect may include a sticker 1742 as shown in FIG. 17C, as an example.

According to an embodiment, when the folding angle of the second hinge structure (e.g., the second hinge structure 450b of FIG. 4) reaches the threshold folding angle (yes in operation 1715), the electronic device (e.g., the processor 120 of FIG. 1) may provide a graphic interface for providing a designated visual effect to at least one target object displayed on the display device 160, in operation 1720. According to an embodiment, unless the folding angle of the second hinge structure (e.g., the second hinge structure 450b of FIG. 4) reaches the threshold folding angle (no in operation 1715), the preview screen may keep on being displayed.

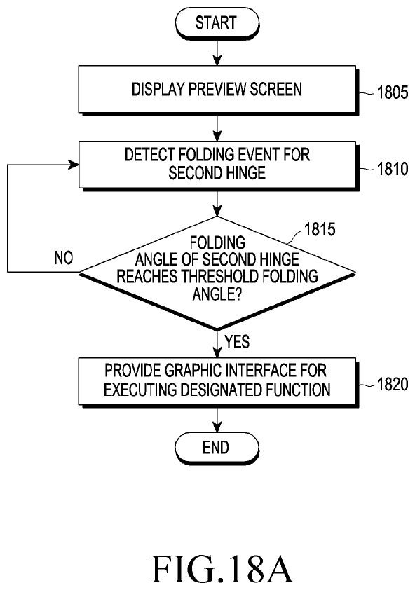

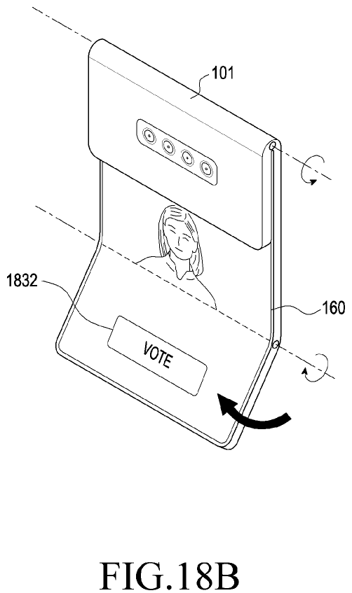

FIGS. 18A and 18B are views illustrating a function or operation for providing a graphic interface for executing a designated function when a folding event occurs on a second hinge structure (e.g., the second hinge structure 450b of FIG. 4).

Referring to FIG. 18A, according to an embodiment, the electronic device (e.g., the processor 120 of FIG. 1) may display a preview screen in operation 1805.

According to an embodiment, the electronic device (e.g., the processor 120 of FIG. 1) may detect a folding event on the second hinge structure (e.g., the second hinge structure 450b of FIG. 4) in operation 1810.

According to an embodiment, the electronic device (e.g., the processor 120 of FIG. 1) may identify whether the folding angle of the second hinge structure (e.g., the second hinge structure 450b of FIG. 4) reaches a threshold folding angle in operation 1815. According to an embodiment, the threshold folding angle may include a reference angle for providing a graphic interface for executing a designated function. According to an embodiment, the designated function may include various functions, such as voting for a certain topic, call sending/receiving, message sending, checking received messages, or running a specific application. According to an embodiment, the electronic device (e.g., the processor 120 of FIG. 1) may display a graphic interface 1832 for executing a designated function (e.g., vote) in a designated area (e.g., the third area 203 of FIG. 2) of the display device 160 as shown in FIG. 18B.

According to an embodiment, when the folding angle of the second hinge structure (e.g., the second hinge structure 450b of FIG. 4) reaches the threshold folding angle (yes in operation 1815), the electronic device (e.g., the processor 120 of FIG. 1) may provide a graphic interface for executing the designated function in operation 1820. According to an embodiment, unless the folding angle of the second hinge structure (e.g., the second hinge structure 450b of FIG. 4) reaches the threshold folding angle (no in operation 1815), the preview screen may keep on being displayed.

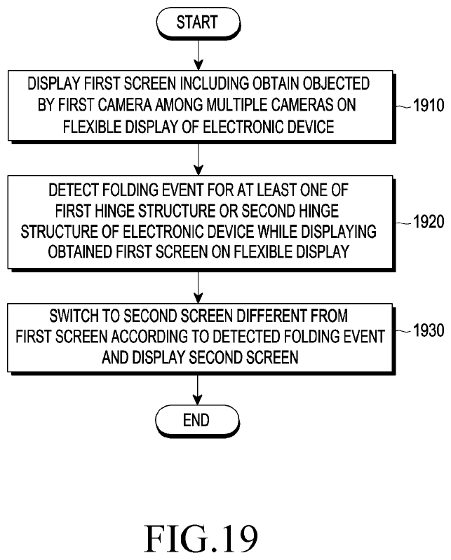

FIG. 19 is a view illustrating an example method of operating an electronic device (e.g., the electronic device 101 of FIG. 1) according to an embodiment.

Referring to FIG. 19, according to an embodiment, the electronic device (e.g., the processor 120 of FIG. 1) may display, on the flexible display of the electronic device, a first screen including an object by a first camera among a plurality of cameras (e.g., the camera 180 of FIG. 2) of the electronic device (e.g., the electronic device 101 of FIG. 1) in operation 1910.

According to an embodiment, the electronic device (e.g., the processor 120 of FIG. 1) may detect a folding event on at least one of the first hinge structure (e.g., the first hinge structure 450a of FIG. 4 or the third hinge structure 810a of FIG. 8) or the second hinge structure (e.g., the second hinge structure 450b of FIG. 4 or the fourth hinge structure 810b of FIG. 8) of the electronic device while displaying the obtained first screen on the flexible display in operation 1920.

According to an embodiment, the electronic device (e.g., the processor 120 of FIG. 1) may switch to the second screen different from the first screen and display the same according to the detected folding event in operation 1930.

According to an embodiment, an electronic device (e.g., the electronic device 101 of FIG. 1) comprises a plurality of cameras (e.g., the camera module 180 of FIG. 1), a foldable housing (e.g., the foldable housing 200 of FIG. 2) including a first hinge structure (e.g., the first hinge structure 450a of FIG. 4) and a second hinge structure (e.g., the second hinge structure 450b), a flexible display (e.g., the display device 160 of FIG. 1) at least partially exposed through the foldable housing, and at least one processor (e.g., the processor 120 of FIG. 1) provided in the foldable housing, the at least one processor configured to display a first screen (e.g., the first preview screen 1030 of FIG. 10b) including an object obtained by a first camera (e.g., the first camera 180a of FIG. 2) among the plurality of cameras on the flexible display, detect a folding event for at least one of the first hinge structure and the second hinge structure while displaying the obtained first screen on the flexible display, and display a second screen (e.g., the second preview screen 1040 of FIG. 10d) different from the first screen on the flexible display according to the detected folding event.

According to an embodiment, the processor (e.g., the processor 120 of FIG. 1) may be configured to increase or decrease a magnification of the first screen according to a variation in angle of at least one of the first hinge structure or the second hinge structure.

According to an embodiment, the processor may be configured to switch the first camera into a second camera (e.g., the third camera 180c of FIG. 2) when an angle formed by at least one of the first hinge structure or the second hinge structure is rendered to reach a designated angle by the angle variation.

According to an embodiment, an area where the first screen (e.g., the first preview screen 1030 of FIG. 10B) is displayed on the flexible display may be larger than an area where the second screen (e.g., the first preview screen 1030 of FIG. 10B) is displayed on the flexible display.

According to an embodiment, the processor (e.g., the processor 120 of FIG. 1) may be configured to switch an operation mode of a camera application according to detection of the folding event.

According to an embodiment, when the second hinge structure is folded at a designated second angle or more, with the first hinge structure folded at a designated first angle or more, the processor may be configured to terminate a designated application being executed.

According to an embodiment, an object (e.g., the screen 1630 for the caller of a video call) obtained by at least one of the plurality of cameras and information (e.g., the screen 1640 for the recipient of the video call) about another party to a call are displayed on the first screen in a picture-in-picture (PIP) manner, and an object (e.g., the screen 1630 for the caller of a video call) obtained by at least one of the plurality of cameras and information (e.g., the screen 1640 for the recipient of the video call) about another party to a call are displayed on the second screen in a split view manner.

According to an embodiment, the processor (e.g., the processor 120 of FIG. 1) may be configured to display, on the flexible display, a menu for executing a designated function according to detection of the folding event.

According to an embodiment, the electronic device (e.g., the electronic device 101 of FIG. 1) may further comprise an angle sensor (e.g., the first sensor 510a, the second sensor 510b, the third sensor 820a, and/or the fourth sensor 820b). The processor may be configured to detect an occurrence of the folding event based on a variation in angle of the first hinge structure and the second hinge structure, sensed by the angle sensor.

According to an embodiment, a least one of the first hinge structure or the second hinge structure may be folded in an in-folding manner.

According to an embodiment, a method for controlling an electronic device (e.g., the electronic device 101 of FIG. 1) comprises displaying a first screen (e.g., the first preview screen 1030 of FIG. 10B) including an object obtained by a first camera (e.g., the first camera 180a of FIG. 2) of a plurality of cameras (e.g., the camera module 180 of FIG. 1) of the electronic device on a flexible display of the electronic device, detecting a folding event for a first hinge structure of the electronic device while displaying the obtained first screen on the flexible display, the first hinge structure connected with a first housing having the plurality of cameras, and switching a second screen (e.g., the second preview screen 1040 of FIG. 10D) different from the first screen and display the second screen according to the detected folding event.

According to an embodiment, an electronic device (e.g., the electronic device 101 of FIG. 1) comprises a plurality of cameras (e.g., the camera module 180 of FIG. 1), a foldable housing (e.g., the foldable housing 200 of FIG. 2) including a first housing (e.g., the first housing structure 210 of FIG. 2) having the plurality of cameras, a second housing (e.g., the second housing structure 220 of FIG. 2) connected with the first housing via a first hinge structure, and a third housing (e.g., the third housing structure 230 of FIG. 2) connected with the second housing via a second hinge structure, a flexible display (e.g., the display device 160 of FIG. 1) at least partially exposed through the foldable housing, and at least one processor (e.g., the processor 120 of FIG. 1) provided in the foldable housing, the at least one processor configured to detect an occurrence of a folding event for the foldable housing, change a capturing mode of the plurality of cameras in response to the occurrence of the folding event on the first hinge structure, and adjust a size of a screen displayed on the flexible display according to a designated magnification and display the screen in response to the occurrence of the folding event on the second hinge structure.

According to an embodiment, the processor (e.g., the processor 120 of FIG. 1) may be configured to continuously increase or decrease a magnification of the screen according to a variation in angle of the second hinge structure.

According to an embodiment, the electronic device (e.g., the electronic device 101 of FIG. 1) may further comprise an angle sensor (e.g., the first sensor 510a, the second sensor 510b, the third sensor 820a, and/or the fourth sensor 820b). Detecting an occurrence of the folding event may include detecting the occurrence of the folding event based on a variation in angle of at least one of the first hinge structure or the second hinge structure, sensed by the angle sensor.

According to an embodiment, the processor may be configured to display, on the flexible display, a menu (e.g., the graphic interface 1832 for executing a designated function of FIG. 18B) for executing a designated function according to detection of the folding event for the second hinge structure.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic device is not limited to the above-listed embodiments.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

As is apparent from the foregoing description, according to an embodiment, there is provided a multi-foldable electronic device with a plurality of hinge structures, capable of providing various functions depending on folding angles of the hinge structures.

The effects set forth herein are not limited thereto, and it is apparent to one of ordinary skill in the art that various effects may be disclosed herein.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device, comprising:
a plurality of cameras;
a foldable housing including a first hinge structure and a second hinge structure;
a flexible display at least partially exposed through the foldable housing; and
at least one processor provided in the foldable housing, the at least one processor configured to:
display on the flexible display a first screen including an object obtained by a first camera among the plurality of cameras,
detect a folding event for at least one of the first hinge structure and the second hinge structure while displaying the first screen on the flexible display, and
display a second screen different from the first screen on the flexible display according to the detection of the folding event.
wherein the processor is further configured to increase or decrease a magnification of the first screen according to a variation in angle of at least one of the first hinge structure or the second hinge structure.

2. The electronic device of claim 1, wherein the processor is further configured to switch the first camera into a second camera when an angle formed by at least one of the first hinge structure or the second hinge structure is rendered to reach a designated angle by the variation in angle.

3. The electronic device of claim 1, wherein an area where the first screen is displayed on the flexible display is larger than an area where the second screen is displayed on the flexible display.

4. The electronic device of claim 1, wherein the processor is further configured to switch an operation mode of a camera application according to the detection of the folding event.

5. The electronic device of claim 1, wherein, when the second hinge structure is folded at a designated second angle or more and the first hinge structure is folded at a designated first angle or more, the processor is further configured to terminate a designated application being executed.

6. The electronic device of claim 1, wherein:
an object obtained by at least one of the plurality of cameras and information about another party to a call are displayed on the first screen in a picture-in-picture (PIP) manner; and
an object obtained by at least one of the plurality of cameras and information about another party to a call are displayed on the second screen in a split view manner.

7. The electronic device of claim 1, wherein the processor is further configured to display on the flexible display a menu for executing a designated function according to the detection of the folding event.

8. The electronic device of claim 1, further comprising an angle sensor,
wherein the processor is further configured to detect an occurrence of the folding event based on a variation in angle of each of the first hinge structure and the second hinge structure sensed by the angle sensor.

9. The electronic device of claim 1, wherein at least one of the first hinge structure or the second hinge structure is folded in an in-folding manner.

10. A method for controlling an electronic device, the method comprising:
displaying on a flexible display of the electronic device a first screen including an object obtained by at least one of a plurality of cameras of the electronic device;
detecting a folding event for a first hinge structure of the electronic device while displaying the first screen on the flexible display, wherein the first hinge structure is connected with a first housing comprising the plurality of cameras; and
displaying a second screen different from the first screen according to the detection of the folding event.

11. The method of claim 10, wherein an area where the first screen is displayed on the flexible display is larger than an area where the second screen is displayed on the flexible display.

12. The method of claim 10, further comprising switching an operation mode of a camera application according to the detection of the folding event.

13. The method of claim 10, further comprising terminating an application being executed when a second hinge structure is folded at a designated second angle or more and the first hinge structure is folded at a designated first angle or more.

14. The method of claim 10, wherein:
an object obtained by at least one of the plurality of cameras and information about another party to a call are displayed on the first screen in a picture-in-picture (PIP) manner; and
an object obtained by at least one of the plurality of cameras and information about another party to a call are displayed on the second screen in a split view manner.

15. The method of claim 10, further comprising displaying on the flexible display a menu for executing a designated function according to the detection of the folding event.

16. The method of claim 10, wherein:
the electronic device includes an angle sensor; and
detecting an occurrence of the folding event includes detecting the occurrence of the folding event based on a variation in angle of each of the first hinge structure and a second hinge structure sensed by the angle sensor.

17. An electronic device, comprising:
a plurality of cameras;
a foldable housing including:
a first housing comprising the plurality of cameras,
a second housing connected with the first housing via a first hinge structure, and
a third housing connected with the second housing via a second hinge structure;
a flexible display at least partially exposed through the foldable housing; and
at least one processor provided in the foldable housing, the at least one processor configured to:
detect an occurrence of a folding event for the foldable housing,
change a capturing mode of the plurality of cameras in response to the detection of the occurrence of the folding event of the first hinge structure, and
adjust a size of a screen displayed on the flexible display according to a designated magnification, and display the screen in response to the detection of the occurrence of the folding event of the second hinge structure.

18. The electronic device of claim 17, wherein the processor is further configured to continuously increase or decrease a magnification of the screen according to a variation in angle of the second hinge structure.

19. The electronic device of claim 17, further comprising an angle sensor,
wherein detecting an occurrence of the folding event includes detecting the occurrence of the folding event based on a variation in angle of at least one of the first hinge structure or the second hinge structure sensed by the angle sensor.
